(19) United States
(12) Patent Application Publication
(10) Pub. No.: US 2015/0253934 A1
(43) Pub. Date: Sep. 10, 2015

(54) OBJECT DETECTION METHOD AND CALIBRATION APPARATUS OF OPTICAL TOUCH SYSTEM

(71) Applicant: PIXART IMAGING INC., HSIN-CHU (TW)

(72) Inventors: YU-CHIA LIN, HSIN-CHU (TW); CHUAN-CHING LIN, HSIN-CHU (TW); YU-HSIN LIN, HSIN-CHU (TW); HAN-PING CHENG, HSIN-CHU (TW); TZUNG-MIN SU, HSIN-CHU (TW); CHIH-HSIN LIN, HSIN-CHU (TW); HSIN-CHI CHENG, HSIN-CHU (TW); CHUN-SHENG LIN, HSIN-CHU (TW); YU-HSIANG HUANG, HSIN-CHU (TW); KUAN-HSU CHEN, HSIN-CHU (TW); CHUN-YI LU, HSIN-CHU (TW)

(21) Appl. No.: 14/615,670

(22) Filed: Feb. 6, 2015

(30) Foreign Application Priority Data
Mar. 5, 2014 (TW) 103107409

(51) Int. Cl. G06F 3/042

(52) U.S. Cl. CPC G06F 3/0428

(57) ABSTRACT

The present disclosure provides an object detection method including: pre-storing a lookup table of touch reference values, wherein the lookup table of touch reference values records a plurality of touch reference values associated with image positions of a plurality of calibration object images formed in calibration images captured by a first image sensor; capturing a first image, wherein the first image has at least an object image corresponding to a pointer formed therein; generating a first light distribution curve according to the first image; defining a first detection region in the first light distribution curve; obtaining at least one touch reference value associated with the object image using the lookup table of touch reference values; comparing at least one brightness value within the first detection region of the first light distribution curve with the at least one touch reference value obtained.

### BACKGROUND

1. Technical Field

The present disclosure relates to an optical touch system, in particular, to an object detection method of an optical touch system and a calibration apparatus for the optical touch system.

2. Description of Related Art

As touch technology advances, touch panels have gradually integrated with display apparatuses to form touch-screen displays which enable users to operate touch-screen displays by direct touch. Optical touch systems have the advantage of high precision, high reliability, multi-touch support, low failure rate, fast response, and no manufacturing limitations, and have been widely used in a variety of mid-size and large scale electronic products such as tourist touring systems and industrial control systems.

A typical optical touch system includes at least an image sensor and a plurality of light-emitting diodes (LED), e.g., infrared LED (IR LED). Briefly, during the operation of the optical touch system, the light-emitting diode operatively emits a light to illuminate a touch surface of the optical touch system. Whenever an object, such as a finger or a stylus, touches the touch surface, the object blocks the light emitted from the LED and forms a shadow pattern on the touch surface. The optical touch system utilizes an image sensor, capturing images across the touch panel, and computes touch positions of the object relative to the touch panel thereafter based on whether the images captured have a shadow pattern formed therein and the image position associated with the shadow pattern, thereby achieving touch control operation.

However, when the optical touch system becomes unable to accurately determine whether the object is touching a touch surface of the touch panel, such as when the object is hovering over the touch surface, erroneous determination can result, causing erroneous operation which affects the operation performance of the optical touch system.

### SUMMARY

Accordingly, exemplary embodiments provide an object detection method and a calibration apparatus for an optical touch system, in which the object detection method and the calibration apparatus enables the optical touch system to quickly and accurately determine whether an approaching object is touching the touch panel of the optical touch system or hovering over the touch panel, thereby effectively improving the recognition rate of the touch point.

An exemplary embodiment of the present disclosure provides an object detection method, which is applicable to an optical touch system having at least an image sensor. The object detection method includes the following steps. A lookup table of touch reference values is first stored in the optical touch system, wherein the lookup table of touch reference values records a plurality of touch reference values associated with image positions of a plurality of calibration object images formed in calibration images captured by the image sensor. A first image is captured next with the image sensor, wherein the first image has at least a first object image corresponding to a pointer formed therein. A first light distribution curve associated with the first image is generated thereafter. Then, a first detection region is defined in the first light distribution curve. At least one touch reference value associated with the image position of the first object image in the first image is next obtained using the lookup table of touch reference values. Afterward, at least one brightness value in the first detection region of the first light distribution curve is compared with the at least one touch reference value obtained.

Moreover, when the comparison result indicates that the pointer is touching the touch panel, a touch position of the pointer relative to the touch panel is computed according to the image position of the object image in the first image; when the comparison result indicates that the pointer is hovering over the touch panel, stopping computing the touch coordinate of the pointer relative to the touch panel and stopping outputting cursor parameters.

An exemplary embodiment of the present disclosure provides a calibration apparatus for an optical touch system, and the calibration apparatus includes a touch panel, at least one light-emitting component, a first image sensor, an auxiliary reference device, and a calibration processing unit. The touch panel includes a first side, a second side, a third side opposite to the first side, and a fourth side opposite to the second side. The light-emitting component operatively generates a light illuminating the touch panel. The first image sensor is disposed at a corner intersected by the first and the second sides, and the sensing area of the first image sensor at least encompassing the second side and the third side of the touch panel. The auxiliary reference device comprises a plurality of reference marks. The reference marks are placed on an auxiliary frame. The reference marks further include at least a first set of reference marks and a second set of reference marks. When the auxiliary reference device is placed on top of the touch panel, the first set of reference marks is positioned on the fourth side and the second set of reference marks is positioned on the third side. The calibration processing unit is coupled to the first image sensor. The calibration processing unit operatively drives the first image sensor to capture a plurality of calibration images containing a plurality of calibration object images corresponding to a plurality of calibration objects disposed on the touch panel and the reference marks. Then, the calibration processing unit obtains a plurality of touch reference values associated with the calibration object images. The calibration processing unit computes the position of each calibration object relative to the touch panel thereafter according to the image positions of the calibration object images and the image positions of the reference marks formed in the calibration images captured thereafter. The calibration processing unit subsequently generates a lookup table of touch reference values according to the positions of the calibration objects relative to the touch panel and the associated touch reference values.

An exemplary embodiment of the present disclosure provides a non-transitory computer-readable media, for storing a computer executable program for the aforementioned object analyzation method of an optical touch system. When the non-transitory computer readable recording medium is read by a processor, the processor executes the aforementioned object detection method.

To sum up, exemplary embodiments provide an object detection method, which is operable to quickly and accurately determine whether an approaching object is touching the touch panel of the optical touch system or hovering over the touch panel by comparing and analyzing the brightness difference between a shadowed region defined in an image captured across the touch panel and a corresponding region defined in a background image. The object detection method further is capable of determining whether or not to compute the touch position of the object detected, which effectively improves the recognition rate of touch points in the optical touch system as well as the overall operation efficiency of the optical touch system.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram of an optical touch system provided in accordance to an exemplary embodiment of the present disclosure.

FIG. 2 is a schematic diagram illustrating the 2D image feature of a background image captured by an image sensor and an associated light distribution curve provided in accordance to an exemplary embodiment of the present disclosure.

FIG. 3A is a schematic diagram illustrating a background light distribution curve and a first light distribution curve associated with a first image containing an object image provided in accordance to an exemplary embodiment of the present disclosure.

FIG. 3B is another schematic diagram illustrating a background light distribution curve and a first light distribution curve associated with a first image containing an object image provided in accordance to another exemplary embodiment of the present disclosure.

FIG. 4 is a diagram illustrating the process of computing brightness difference between the first light distribution curve and the background light distribution curve provided in accordance to the exemplary embodiment of the present disclosure.

FIG. 5 is a flowchart diagram illustrating an object detection method of an optical touch system provided in accordance to an exemplary embodiment of the present disclosure.

FIG. 6 is a flowchart diagram illustrating an object detection method of an optical touch system provided in accordance to another exemplary embodiment of the present disclosure.

FIG. 7 is a flowchart diagram illustrating an object detection method of an optical touch system provided in accordance to another exemplary embodiment of the present disclosure.

FIG. 8 is a flowchart diagram illustrating an object detection method of an optical touch system provided in accordance to another exemplary embodiment of the present disclosure.

FIG. 9 is a flowchart diagram illustrating an object detection method of an optical touch system provided in accordance to further another exemplary embodiment of the present disclosure.

FIG. 10 is a flowchart diagram illustrating the method of defining the first detection region provided in accordance to another exemplary embodiment of the present disclosure.

FIG. 11 is a diagram of a calibration apparatus of an optical touch system provided in accordance to an exemplary embodiment of the present disclosure.

FIG. 12A˜FIG. 12C are schematic diagrams respectively illustrating the disposition of calibration objects provided in accordance to an exemplary embodiment of the present disclosure.

FIG. 13 is a flowchart diagram illustrating a calibration method for an optical touch system provided in accordance to an exemplary embodiment of the present disclosure.

FIG. 14 is a flowchart diagram illustrating a method for obtaining touch reference values provided in accordance to another exemplary embodiment of the present disclosure.

FIG. 15 is a diagram of an optical touch system provided in accordance to another exemplary embodiment of the present disclosure.

FIG. 16-1 and FIG. 16-2 are flowchart diagrams illustrating an object detection method of an optical touch system provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Drawings are provided in the present disclosure to illustrate the general structures of the present disclosure, some sizes of structures or portions in the drawings provided may be exaggerated relative to sizes of other structures or portions for illustration purposes. It shall be appreciated by those of skill in the art, relative terms and phrases such as “on” or “over” are used herein to describe one structure's or portion's relationship to another structure or portion as illustrated in the drawings. It shall be understood that such relative terms are intended to encompass different orientations of the device in addition to the orientation depicted in the drawing. For example, if the component or the device in the drawing is turned over, rotated, or both, the structure or the portion described as “on” or “over” other structures or portions would now be oriented “below,” “under,” “left of,” “right of,” “in front of,” or “behind” the other structures or portions.

(An Exemplary Embodiment of an Optical Touch System)

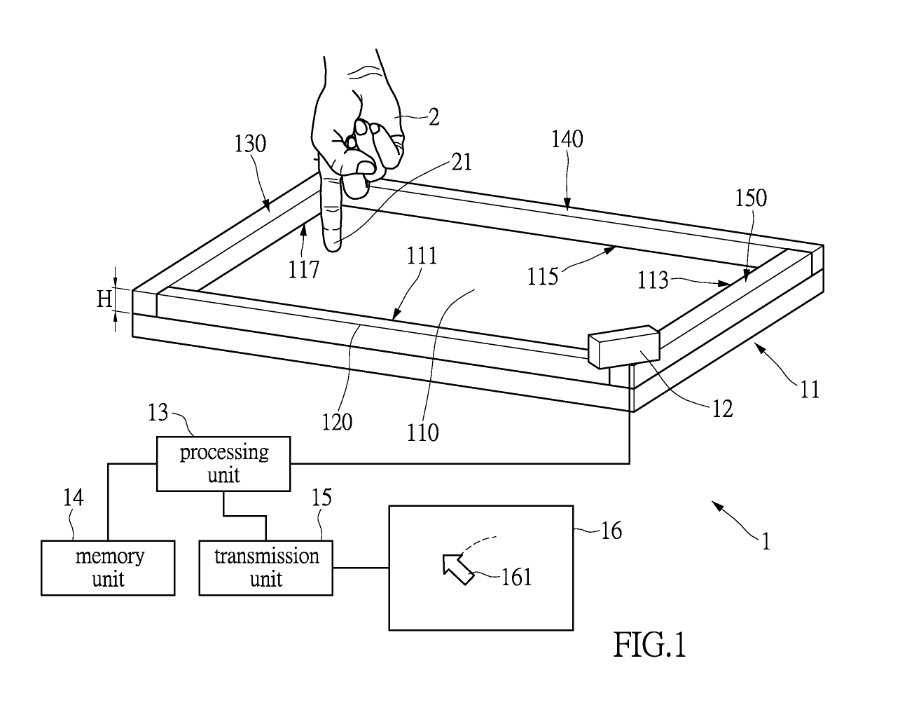

Please refer to FIG. 1, which shows a diagram illustrating an optical touch system provided in accordance to an exemplary embodiment of the present disclosure. An optical touch system 1 is configured to operatively sense a touch position of at least one pointer. In the instant embodiment, the pointer herein is a finger 21 of a user 2. In other embodiments, the pointer can be a stylus, a touch stick, or any other touch object, and the instant embodiment is not limited thereto.

The optical touch system 1 includes a touch panel 11, an image sensor 12, a light-emitting component 120, a reflective mirror 130, a first reflecting unit 140, a second reflecting unit 150, a processing unit 13, a memory unit 14, a transmission unit 15, and a display apparatus 16. The light-emitting component 120, the image sensor 12, the memory unit 14, and the transmission unit 15 are coupled to the processing unit 13, respectively. The transmission unit 15 is coupled to the display apparatus 16. Briefly, during the operation of the optical touch system 1, the processing unit 13 operatively controls the operation of a cursor 161 displayed on the display apparatus 16 based on the sensing result of the image sensor 12.

The image sensor 12, the light-emitting component 120, the reflective mirror 130, the first reflecting unit 140, and the second reflecting unit 150 are respectively disposed on the touch panel 11. The touch panel 11 can be a whiteboard, a transparent board (e.g., glass board or plastic board), or a touch screen.

In the instant embodiment, the touch panel 11 is substantially a rectangular-shaped board. The touch panel has a touch surface 110, and the touch surface 110 is also rectangular-shaped. The touch surface 110 is a reflective mirror or a reflecting surface. Specifically, the touch panel 11 has four straight sides, i.e., a first side 111, a second side 113, a third side 115 opposite to the first side 111, and a fourth side 117 opposite to the second side 113. The first side 111 intersects with the second side 113 forming a first corner; the first side 111 intersects with the fourth side 117 forming a second corner; the second side 113 intersects with the third side 115 forming a third corner; the third side 115 intersects with the fourth side 117 forming a fourth corner.

The region surrounded by the touch surface 110, the light-emitting component 120, the reflective mirror 130, the first reflecting unit 140, and the second reflecting unit 150 forms a touch sensing region TR of the optical touch system 1. The touch sensing region TR has a height H, wherein the height H may be configured based on the exact structure of the optical touch system 1 and the operation requirement thereof.

The light-emitting component 120 is disposed at the first side 111 of the touch panel 11. The light-emitting component 120 is configured to provide necessary lighting supporting the operation of the optical touch system 1. The light-emitting component 120 can be configured to emit invisible light, (e.g. infrared light or ultraviolet light,) illuminating the entire touch panel 11.

In one embodiment, the light-emitting component 120 may include a plurality of light-emitting elements which may be arranged along the first side 111 of the touch panel 11. In another embodiment, the light-emitting component 120 may include a light-emitting element and a light guide (e.g., light guide plate). The light-emitting element scatters light to the light guide, and the light guide evenly distributes the light to the touch panel 11. The light-emitting element described herein can be an infrared light emitting diode (IR LED) or an ultraviolet light emitting diode (UV LED). It is worth to mention that the light emitted by the light-emitting component 120 may also be visible light. It shall be noted that the exact implementation of the light-emitting component 120 may be determined based on the practical operation of the optical touch system 1 and the instant embodiment is not limited thereto.

The reflective mirror 130 is disposed at the fourth side 117 of the touch panel 11, and the reflective mirror 130 is protruded above the touch surface 110. More specifically, in the instant embodiment, the reflective mirror 130 extends a height H in an upper direction from the touch surface 110. The reflective mirror 130 has a reflecting surface facing the touch panel 11 for reflecting the invisible light emitted from the light-emitting component 120 onto the touch panel 11.

The reflective mirror 130 is also configured to generate a mirror image of the touch sensing region TR, and generate a mirror image of the pointer (not shown) being controlled to perform operations on the touch surface 110. The reflective mirror 130 can be implemented by a planar mirror. The reflecting surface of the reflective mirror 130 is configured to face the touch sensing region TR.

The first reflecting unit 140 is disposed at the third side 115 of the touch panel 11. The second reflecting unit 150 is disposed at the second side 113 of the touch panel 11. The first reflecting unit 140 and the second reflecting unit 150 respectively protrude above the touch surface 110. The first reflecting unit 140 and the second reflecting unit 150 may be for example made of reflective cloth. The first reflecting unit 140 and the second reflecting unit 150 are configured to face the touch sensing region TR, to respectively reflect the light emitted from the light-emitting component 120. The first reflecting unit 140 and the second reflecting unit 150 respectively extend a height H in the upper direction from the touch surface 110.

In the instant embodiment, the heights of the reflective mirror 130, the first and the second reflecting units 140, 150 are all configured to be height H. However, it shall be understood by those skilled in the art, the exact heights of the reflective mirror 130, the first and the second reflecting units 140, 150 may be configured according to the practical operation requirement of the optical touch system 1.

The first and the second reflecting units 140, 150 can be implemented with retro-reflective material to attain light reflecting effect, however, the instant embodiment is not limited thereto so long as the first and the second reflecting units 140, 150 can reflect the light emitted by the light-emitting component 120 onto the touch surface 110 and preferably not generate the mirror image of the touch sensing area TR. In other embodiments, the first and the second reflecting units 140, 150 may each be replaced by one or more light-emitting components, so long as the light-emitting component(s) disposed are all configured to face and illuminate the touch surface 110.

The image sensor 12 is positioned at the first corner of the touch panel 11. In another embodiment, the image sensor 12 may also be positioned at the second corner, the third corner or integrated with the light-emitting component 120 (i.e., placed on top of the light-emitting component 120) so long as the image sensor 12 is placed at the position that is opposite to the position of the reflective mirror 130.

The image sensor 12 is configured to operatively sense the touch operation of the pointer (i.e., the finger 21 of the user 2) in the touch sensing region TR. Specifically, the image sensor 12 is configured to capture a plurality of images across the touch panel 11 including the touch sensing region TR surrounded by the touch surface 110, the reflective mirror 130, the first reflecting unit 140, and the second reflecting unit 150. The images captured at least include a background image and an image containing an object image that corresponds to the position of the pointer on the touch panel 11. The background image is the image captured across the touch panel 11 during the time period that the pointer has not approached the touch panel 11, and the background image captured by the image sensor 12 across the touch panel encompasses the touch sensing region by the image sensor 12.

The field of view of the image sensor 12 can be configured to lean toward the touch surface 110 and the leaning angle thereof can be configured according to the exact installation requirement and the range of image sensing area required, so long as the image sensor 12 can view across the touch sensing region TR of the touch panel 11. The longitudinal field of view of the image sensor 12 is preferably configured to be greater than the height of the touch sensing region TR.

The image sensor 12 may further include a filter (e.g., IR-pass filter) for allowing only lights with specified wavelengths (e.g., IR light) to be sensed and received.

The image sensor 12 can be implemented by a charge-coupled device (CCD) image sensor or a complementary metal oxide semiconductor (CMOS) image sensor. Those skilled in the art should be able to design and implement the image sensor 12 according to the practical operation requirements and the instant embodiment is not limited thereto.

The processing unit 13 is configured to operatively drive the image sensor 12 to capture 2D images across the touch panel 11 according to a predetermined frame rate. The processing unit 13 transforms (or converts) the 2D images captured into 1D light distribution curves, respectively. The processing unit 13 determines whether the pointer (i.e., the finger 21) is touching (or in contact with) the touch surface 110 of the touch panel 11 or is hovering over the touch surface 110 thereafter according to the light distribution information conveyed by the 1D light distribution curves. The processing unit 13 further decides whether to compute a touch position (e.g., touch coordinate) of the pointer relative to the touch panel 11 according to the determination result of the pointer.

When the processing unit 13 determines that the pointer touches or contacts the touch panel 11, the processing unit 13 computes a touch position of the pointer relative to the touch panel 11. The processing unit 13 further drives the transmission unit 15 to transmit the coordinate information of the touch position to the display apparatus 16 and correspondingly controls the operation of the cursor 161 displayed on the display apparatus 16, e.g., control the movement of the cursor 161, or control the cursor 161 to perform writing operations, select operation, or the like.

The memory unit 14 is configured to store images captured by the image sensor 12 and the related touch attributes or touch parameters for determining whether the pointer is touching the touch surface 110 or is hovering over the touch surface 110. The memory unit 14 further can store coordinate information associated with the touch position of the pointer relative to the touch panel 11.

The memory unit 14 is configured to store a lookup table of touch reference values, wherein the lookup table of touch reference values records a plurality of touch reference values that correspond to image positions of a plurality of calibration object images contained in a plurality of first calibration images captured by the image sensor 12. The lookup table of touch reference values contains at least one touch reference value associated with the image position of each calibration object image in the first calibration images captured. The touch reference values may be the brightness information of the image and include at least one of a predefined brightness value, a predefined average brightness value, a predefined brightness difference value, and a predefined average brightness difference value. The lookup table of touch reference values may be generated by executing a calibration program with a calibration apparatus and pre-stored in the memory unit 14 before factory shipment of the optical touch system 1. Detail regarding generation of the lookup table of touch reference values will be described in another embodiment and further descriptions are hereby omitted.

During the operation of the optical touch system 1, the processing unit 13 drives the image sensor 12 to capture a first image across the touch panel 11 according to the predetermined frame rate. The processing unit 13 operatively transforms (or converts) the first image into a first light distribution curve and defines a first detection region in the first light distribution curve thereafter. The position of the first detection region corresponds to the image position of the objet image formed corresponding to the pointer in the first image. The processing unit 13 subsequently determines whether the pointer is touching (or in contact with) the touch surface 110 or hovering over the touch surface 110 according to one or more brightness values in the first detection region.

More specifically, the processing unit 13 may determine whether the pointer is touching the touch surface 110 of the touch panel 11 or hovering over the touch surface 110 by comparing one or more brightness values in the first detection region with at least one of the touch reference values associated with the image position of the object image in the first image.

When the processing unit 13 determines that the pointer is touching the touch surface 110, the processing unit 13 computes the touch position of the pointer relative to the touch panel 11 according to the image position of the object image formed in correspondence to the pointer in the image (e.g., the first image) and the image position of the mirror image of the pointer (i.e., the object image mirrored by the reflective mirror 130) formed in the image.

It shall be understood that the phrase of “in contact with the touch surface 110” and the phrase of “touching the touch surface 110” have the same meaning throughout the entire context of the present disclosure and are therefore used interchangeably.

It is worth to note that computing the touch position associated with the pointer in the optical touch system by utilizing the triangulation computation method is a known art. Those skilled in the art may for example employ the algorithm disclosed in U.S. Pat. No. 8,269,158 and compute the two-dimensional coordinate of the touch pointer. Moreover, methods adopted for computing the touch position associated with the pointer in the optical touch system are not the main focus of the instant disclosure and hence further descriptions are hereby omitted.

Detailed descriptions regarding the generation of the first light distribution curve and the definition of the first detection region are provided in the following paragraphs.

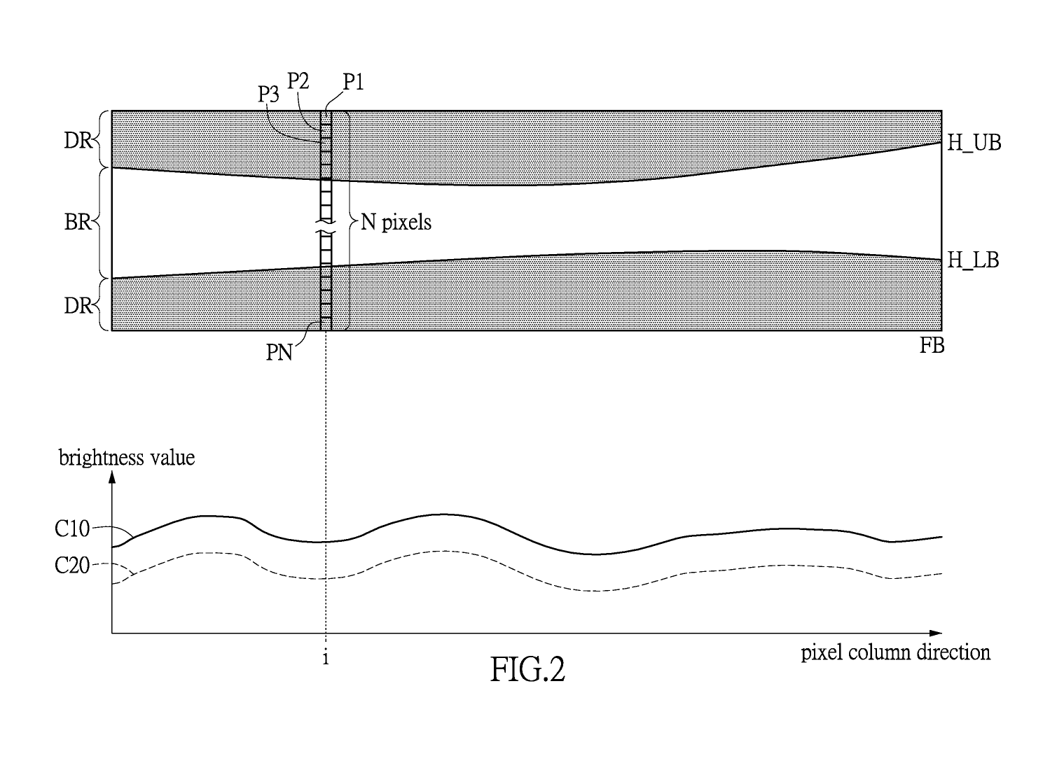

Please refer to FIG. 2 in conjunction with FIG. 1, wherein FIG. 2 shows a schematic diagram illustrating the 2D image feature of a background image captured by an image sensor and a light distribution curve thereof provided in accordance to an exemplary embodiment of the present disclosure. Curve C10 represents a background light distribution curve of a background image FB. Curve C20 represents a predetermined brightness threshold curve derived from curve C10.

At the startup of the optical touch system 1 before the pointer approaches or enters the touch sensing region TR, the processing unit 13 can drive the image sensor 12 to sense and capture a background image FB across the touch surface 110. Since the longitudinal field of view (or the longitudinal sensing area) of the image sensor 12 in the instant embodiment is larger than the height of the touch sensing region TR, therefore the background image FB captured by the image sensor 12 includes a background region DR and a bright region BR as shown in FIG. 2. The background image FB has M×N pixels, wherein M and N are integers.

The height of the bright region BR is determined by the touch surface 110, the reflective mirror 130, the first reflecting unit 140, and the second reflecting unit 150. More specifically, since the light-emitting component 120, the reflective mirror 130, the first reflecting unit 140, and the second reflecting unit 150 emit or reflect light, therefore a bright region BR of relatively high brightness, will form in the image captured by the image sensor 12.

The background region DR encompasses the region outside the touch surface 110, the reflective mirror 130, the first reflecting unit 140, and the second reflecting unit 150. Since the background region DR does not have any light reflecting component to reflect the light emitted from the light-emitting component 120, hence the background region DR is relatively dark. In the instant embodiment, the touch surface 110 is a reflective mirror, hence the background region DR beneath the bright region BR is a virtual image generated by the touch surface 110 via reflection.

It is worth to note that the touch surface 110 may be a non-reflecting surface. When the touch surface 110 is a non-reflecting surface, images captured across the touch surface 110 by the image sensor 12 include only the region encompassed by the reflective mirror 130, the first reflecting unit 140 and the second reflecting unit 150 and does not include the mirror image reflected from the touch surface 110. Accordingly, the background image FB only contains a bright region BR and a background region DR positioned or formed above the bright region BR.

Next, the processing unit 13 can compute the average brightness value of the background image FB. The processing unit 13 further sets a predetermined pixel value according to the average brightness value of the background image FB and a preset weighting factor α1 (e.g., 1.2). In one embodiment, the preset weighting factor α1 may be configured according to a standard deviation of the average brightness value of the background image FB.

Then, the processing unit 13 compares the pixel values of each of the N pixels P1·PN in each pixel column of the background image FB with the predetermined pixel value and sets the area in each pixel column containing the most number of pixels with a pixel value greater than the predetermined pixel value to be the bright block of each respective pixel column. The processing unit 13 subsequently defines an upper brightness bound H_UB and a lower brightness bound H_LB in each pixel column of the background image FB according to the bright block of each respective pixel column, so as to define the bright region BR in the background image FB. The pixel values lying between the upper brightness bound H_UB and the lower brightness bound H_LB are greater than the predetermined pixel value.

In another embodiment, the processing unit 13 may also compute the average pixel value of N pixels P1˜PN for each pixel column, and then sets a predetermined pixel value for each pixel column according to the average pixel value of each respective pixel column computed and the preset weighting factor α1.

Afterwards, the processing unit 13 correspondingly transforms the background image FB from a 2D image feature into a 1D light distribution curve (i.e., curve C10) by summing the pixel values of the pixels in each pixel column within the bright region BR of the background image FB. For instance, the brightness value of the ith pixel column of curve C10 represents the sum of the pixel values of the pixels of the ith pixel column in the bright region BR of the background image FB, wherein i is a positive integer. Moreover, the processing unit 13 may further derive curve C20 from curve C10 to serve as a predetermined brightness threshold curve for the background image FB, so as to provide appropriate brightness sensitivity tolerance during the operations of sensing the touch state of the pointer and detecting the touch position of the pointer and eliminate the impact of environment noise on the image sensor 12. Curve 20 can be the product between curve C10 and a preset percentage (e.g., 80%); in particular, curve C20 may be a product of curve C10 and a brightness weighting factor α2.

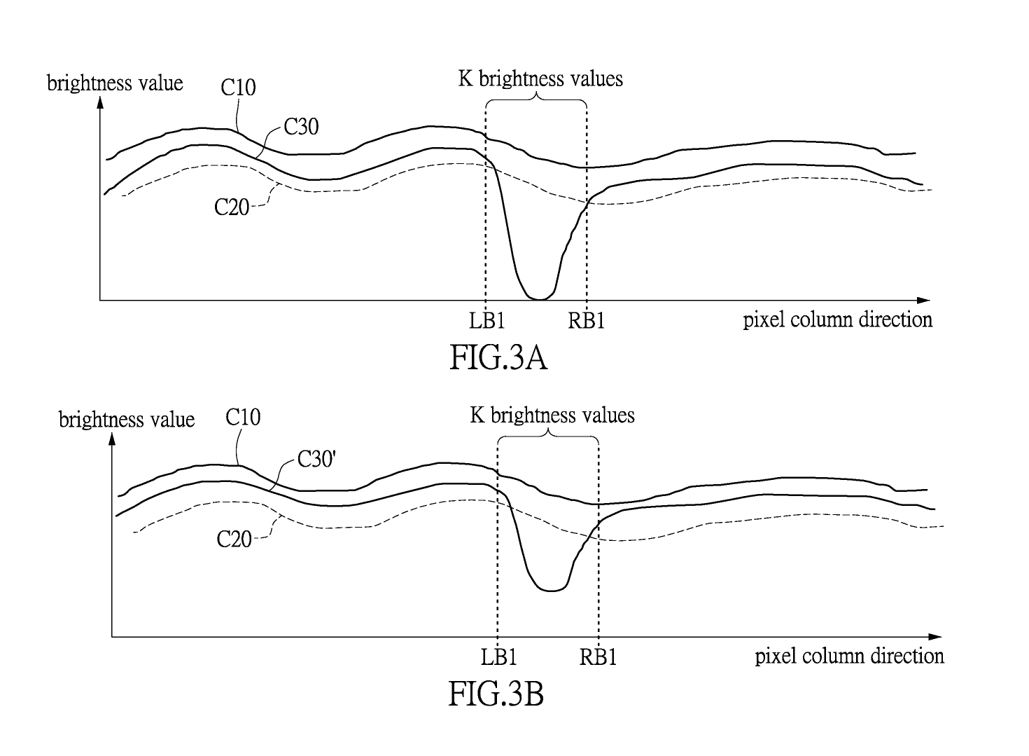

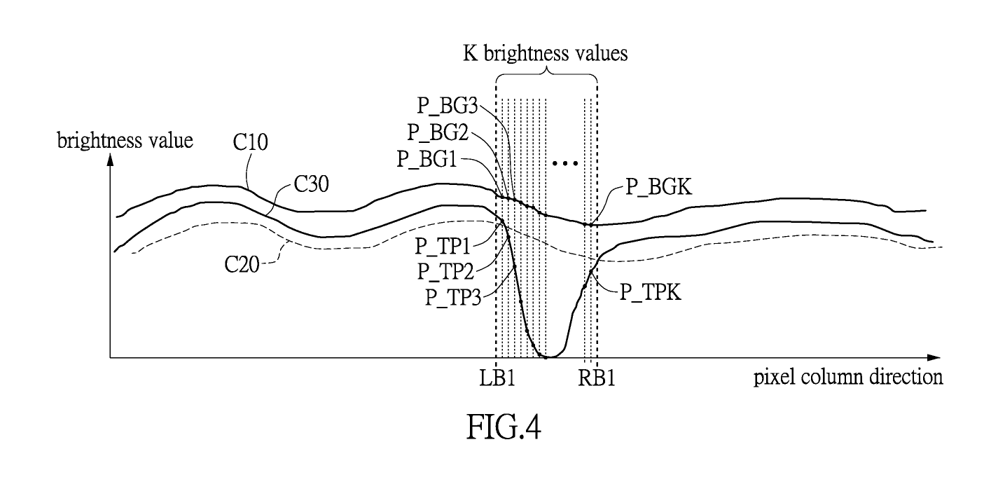

Please refer to FIG. 3A and FIG. 3B in conjunction with FIG. 1. FIG. 3A and FIG. 3B, each shows a schematic diagram illustrating a background light distribution curve and a first light distribution curve associated with a first image containing an object image corresponding to the pointer provided in accordance to an exemplary embodiment of the present disclosure. Curve C30 and curve C30′, each illustrates a first light distribution curve that corresponds to the bright region of the first image captured.

When the finger 21 of the user 2 enters the touch sensing region TR and approaches or comes near the touch surface 110, the first image captured by the image sensor 12 includes the object image (not shown) formed as the tip of the finger 21 or the finger pulp of the finger 21 partially blocks or shields the reflective mirror 130 or the first reflecting unit 140 and may or may not include the object image (not shown) of the finger 21 reflected from the touch surface 110. Since the touch surface 110 of the instant embodiment is a reflective mirror, therefore the first image captured by the image sensor 12 at the same time includes the object image that corresponds to the mirror image of the finger 21 generated by the touch surface 110 via reflection.

The processing unit 13 operatively defines a bright region BR in the first image according to the position of the bright region in the background region FB. The processing unit 13 sums the brightness values of all pixels in each pixel column inside the bright region BR (i.e., summing the pixel values of all the pixels in each pixel column inside the bright region BR) of the first image to generate the first light distribution curve associated with the bright region of the first image, i.e., curve C30 or curve C30′. In one embodiment, the processing unit 13 may sum a portion of pixels from each pixel column inside the bright region BR to generate the first light distribution curve associated with of the first image. In another embodiment, the processing unit 13 may compute the sum of a portion of pixels from each pixel column inside the bright region BR and subtract the sum of the other portion of pixels from each respective pixel column inside the bright region BR to generate the first light distribution curve associated with of the first image. Curve C30 represents the light distribution or the brightness curve as the finger 21 touches the touch surface 110 and curve C30 represents the light distribution or the brightness curve when the finger approaches but is not in contact with the touch surface 110 (i.e., hovering over the touch surface). It can be noted from FIG. 3A and FIG. 3B, when the finger 21 touches or is in contact with the touch surface 110, the brightness of the first detection region of the first light distribution is relatively lower than that of the first image depicting the finger coming near but not in contact with the touch surface 110.

Moreover, the processing unit 13 operatively defines the first detection region by defining the first left boundary LB1 and the first right boundary RB1 associated with the object image (i.e., the real and the mirror object images of the pointer) of the first image according to the predetermined brightness threshold curve, wherein the predetermined brightness threshold curve (i.e., curve C20) is derived from the first light distribution curve (i.e., curve C30).

The processing unit 13 subsequently determines whether the pointer is touching or is hovering over the touch surface 110 of the touch panel 11 by analyzing the K brightness values in the first detection region of the first light distribution curve (i.e., curve C30, C30′), wherein K is an integer.

In one embodiment, the processing unit 13 may first obtain a predefined brightness value, which is associated with the image position of the object image formed in the first image, from the lookup table of touch reference values. The processing unit 13 then analyzes the touch state of the pointer by comparing the minimum brightness value of brightness values (i.e., K brightness values) in the first detection region of the first light distribution curve with the predefined brightness value. When the processing unit 13 determines that the minimum brightness value of brightness values in the first detection region of the first light distribution curve is less than the predefined brightness value, the processing unit 13 determines that the pointer is touching the touch surface 110 of the touch panel 11. On the other hand, when the processing unit 13 determines that the minimum brightness value of brightness values in the first detection region of the first light distribution curve is greater than or equal to the predefined brightness value, the processing unit 13 determines that the pointer is hovering over the touch surface 110.

In another embodiment, the processing unit 13 can first compute the average brightness value of brightness values in the first detection region of the first light distribution curve. The processing unit 13 obtains a predefined average brightness value, which is associated with the image position of the object image formed in the first image, from the lookup table of touch reference values. The processing unit 13 then analyzes the touch state of the pointer by comparing the average brightness value of brightness values (i.e., the K brightness values) in the first detection region of the first light distribution curve with the predefined average brightness value. When the processing unit 13 determines that the average brightness value of brightness values in the first detection region of the first light distribution curve is less than the predefined average brightness value, the processing unit 13 determines that the pointer is touching the touch surface 110 of the touch panel 11. On the other hand, when the processing unit 13 determines that the average brightness value of brightness values in the first detection region of the first light distribution curve is greater than or equal to the predefined average brightness value, the processing unit 13 determines that the pointer is hovering over the touch surface 110.

In short, when the minimum brightness value of the first detection region is determined to be less than the predefined brightness value or the average brightness value of the first detection region is determined to be less than the predefined average brightness value, this indicates that the pointer is close to the touch surface 110 and the greater the depth that the first detection region is covered, therefore, the processing unit 13 determines that the pointer is touching the touch surface 110.

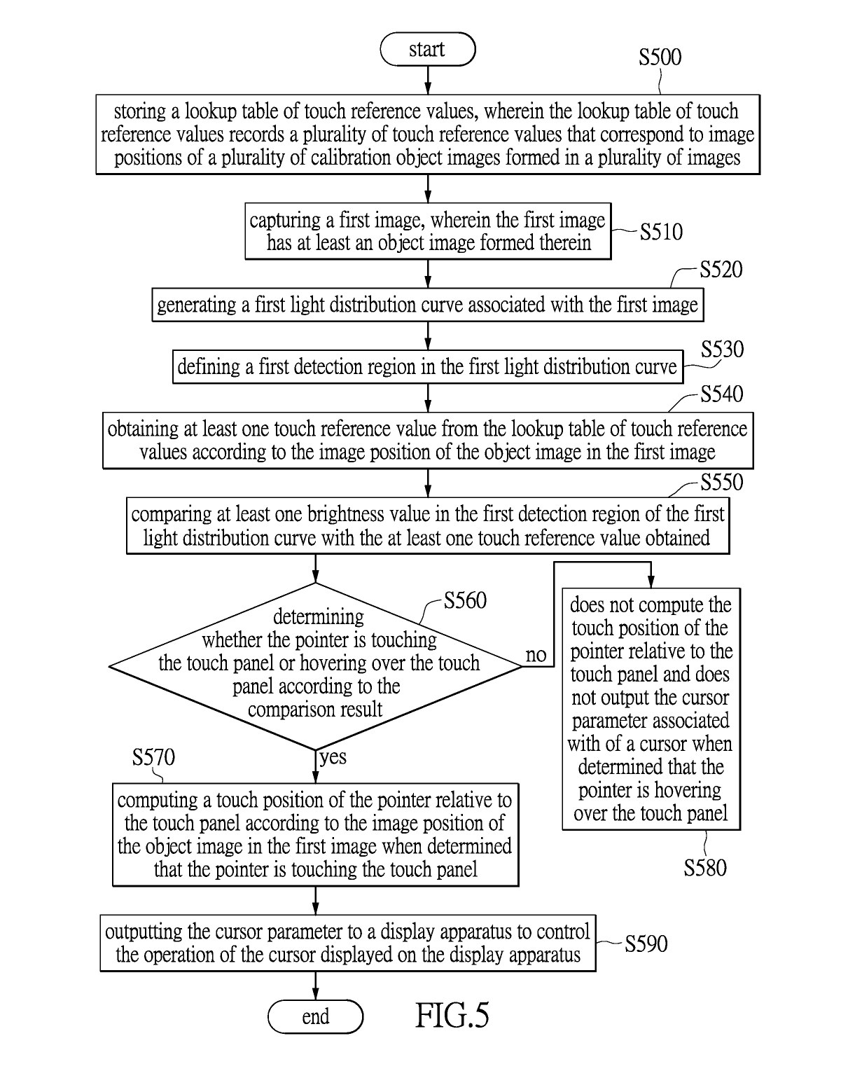

In another further embodiment, the processing unit 13 may determine the touch state of the pointer based on the brightness difference between the first light distribution curve (i.e., curve C30 or C30′) and the background light distribution curve (i.e., curve C10). Please refer to FIG. 4 in conjunction with FIG. 1, wherein FIG. 4 shows a diagram illustrating the process of computing brightness difference between the first light distribution curve and the background light distribution curve provided in accordance to the exemplary embodiment of the present disclosure.

The processing unit 13 in the instant embodiment computes the difference between the brightness values in the first detection region of the first light distribution region (i.e., curve C30, C30′) and the respective brightness values in the background light distribution curve (i.e., curve C10) More specifically, the processing unit 13 sequentially computes the brightness difference (i.e., |P_TPn−P_BGn|) between each of brightness values P_TP1˜P_TPK of the first light distribution curve and each of the respective brightness values P+BG1˜PBGK of the background light distribution curve in a direction from the first left boundary LB1 toward the first right boundary RB1, so as to generate a first brightness difference data, wherein n is an integer lying between 1 and K. The processing unit 13 further determines whether the pointer is touching the touch surface 10 according to at least one brightness difference value of the first brightness difference data.

Specifically, the processing unit 13 can determine the luminance degradation of the first detection region by comparing the maximum brightness difference value of a plurality of brightness difference values in the first brightness difference data with the predefined brightness difference value recorded in the lookup table of touch reference values, wherein the predefined brightness difference value is a touch reference value associated with the image position of the object image formed in the first image. When the processing unit 13 determines that the maximum brightness difference value of the first brightness difference data is greater than the predefined brightness difference value, the processing unit 13 determines that the pointer is touching the touch surface 110. On the other hand, when the processing unit 13 determines that the maximum brightness difference value of the first brightness difference data is less than or equal to the predefined brightness difference value, the processing unit 13 determines that the pointer is hovering over the touch surface 110.

The processing unit 13 can also compare the average brightness difference value of the plurality of brightness difference values in the first brightness difference data with a predefined average brightness difference value recorded in the lookup table of touch reference values, wherein the predefined average brightness difference value corresponds to the image position of the object image formed in the first image. When the processing unit 13 determines that the average brightness difference value of the first brightness difference data is greater than the predefined average brightness difference value, the processing unit 13 determines that the pointer is touching the touch surface 110. On the other hand, when the processing unit 13 determines that the average brightness difference value of the first brightness difference data is less than or equal to the predefined brightness difference value, the processing unit 13 determines that the pointer is hovering over the touch surface 110.

That is to say, when the maximum brightness difference value of the first brightness difference data is greater than the predefined brightness difference value or when the average brightness difference value of the first brightness difference data is greater than the predefined average brightness difference value, this indicates that the pointer is close to the touch surface 110 and the greater the depth that the first detection region is covered, therefore, the processing unit 13 determines that the pointer is touching the touch surface 110.

In practice, the processing unit 13 can accurately determine the current touch state of the pointer by sequentially comparing the minimum brightness value of the brightness values in the first detection region of the first light distribution curve, the average brightness value of the brightness values in the first detection region of the first light distribution curve, the maximum brightness difference value between the first light distribution curve and the background light distribution curve over the first detection region, and the average brightness difference value between the first light distribution curve and the background light distribution curve over the first detection region with the corresponding touch reference values recorded in the lookup table of touch reference values.

In short, when the pointer approaches or comes near the touch surface 110, the processing unit 13 can quickly and accurately determine the touch state of the pointer by first transforming the first image containing the object image captured by the image sensor 12 into the first light distribution curve and comparing at least one brightness value in the first detection region of the first light distribution curve with at least one of the touch reference values recorded in the lookup table of touch reference values thereafter.

The processing unit 13 in the instant embodiment can be implemented by a processing chip such as a microcontroller or an embedded controller programmed with necessary firmware, however the present disclosure is not limited to the example provided herein. The memory unit 14 can be implemented by a volatile memory chip or a nonvolatile memory chip including but not limited to a flash memory chip, a read-only memory chip, or a random access memory chip. The transmission unit 15 can be configured to transmit the coordinate information of the touch position to the display apparatus 16 in wired or wireless manner, and the present disclosure is not limited thereto.

In another embodiment, when a passive light source, such as a reflective mirror, is used in place of the light-emitting component 120 of the optical touch system 1, at least a light-emitting element may be further disposed on the sides of the touch surface 110 (e.g., at the intersection between the first side 111 and the second side 113) such that the light-emitting component 120 and the reflective mirror 130 can reflect the light emitted from the light-emitting element and illuminate the touch surface 110 by reflection. In one embodiment, the light-emitting component 120 may be fixedly positioned or mounted on the image sensor 12. For instance, the light-emitting component 120 may be integrated with the image sensor 12 by techniques such as sticking, screwing or fastening, so as to fixedly position or mount the light-emitting component 120 on the image sensor 12.

In another embodiment, the optical touch system 1 may not have the light-emitting component 120 installed thereon and the image sensor 12 may have an illumination device (e.g., an infrared IR illumination device having an IR LED) disposed thereon. The image sensor 12 may further include an IR filter module (e.g., IR pass filter) such that the image sensor 12 captures images of the touch surface 110 with the IR filter module.

The touch panel 11 of the optical touch system 1 and the display apparatus 16 in the instant embodiment are separate pieces, but in other embodiments, the touch panel 11 may be integrated with the screen of the display apparatus 16. For instance, when the touch panel 11 is a touch screen (e.g., a transparent touch screen), the screen of the display apparatus 16 may be configured to serve as the touch panel 11. The reflective mirror 130, the reflecting unit 140, and the second reflecting unit 150 can be respectively disposed on the screen of the display apparatus 16.

As shown in FIG. 1, the touch panel 11 is rectangular shaped, and the light-emitting component 120, the reflective mirror 130, the first reflecting unit 140, and the second reflecting unit 150 are perpendicularly disposed on four sides of the touch panel 11. However, in another embodiment, the touch panel 11 may be made of any other geometric shapes such as a square or circular, and the light-emitting component 120, the reflective mirror 130, the first reflecting unit 140, and the second reflecting unit 150 may be disposed on the touch panel 11, accordingly.

It should be noted that the exact type, the exact structure and/or the exact implementation associated with the panel 11, the image sensor 12, the light-emitting component 120, the reflective mirror 130, the first reflecting unit 140, the second reflecting unit 150, the processing unit 13, the memory unit 14, the transmission unit 15, and the display apparatus 16 may vary according to specific design (e.g., the exact type, the exact structure and/or the exact implementation) and/or operational requirement of the optical touch system 1, and should not be limited to the examples provided by the instant embodiment.

(An Exemplary Embodiment of an Object Detection Method for an Optical Touch System)

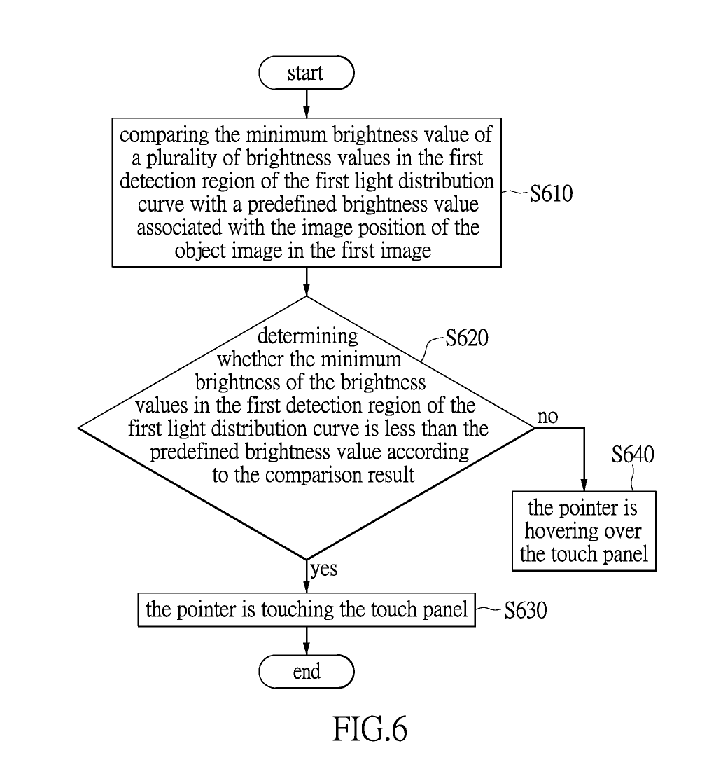

From the aforementioned exemplary embodiments, the present disclosure can generalize an object detection method for the optical touch system described in FIG. 1. Please refer to FIG. 5 in conjunction with FIG. 1, wherein FIG. 5 shows a flowchart diagram illustrating an object detection method of an optical touch system provided in accordance to an exemplary embodiment of the present disclosure. During the operation of the optical touch system 1, the processing unit 13 drives the image sensor 12 to capture a plurality of images across the touch surface 110 of the touch panel 11 according to a predetermined frame rate, so as to detect whether or not a pointer approaches or comes near the touch surface 110. The predetermined frame rate may be configured according to the actual application and the operating environment (e.g., the surrounding brightness or the ambient light setting) associated with the optical touch system 1, and the instant embodiment is not limited thereto.

In Step S500, a lookup table of touch reference values is pre-stored in the memory unit 14. The lookup table of touch reference values records a plurality of touch reference values associated with image positions of a plurality of calibration object images formed in a plurality of images captured by the image sensor 12. The lookup table of touch reference values records at least contains one touch reference value associated with the image position of each calibration object image formed in images captured. The touch reference values may be the brightness information of the image and include at least one of a predefined brightness value, a predefined average brightness value, a predefined brightness difference value, and a predefined average brightness difference value.

In Step S510, the processing unit 13 drives the image sensor 12 to capture a first image across the touch surface 110, wherein the first image has an object image corresponding to the position of a pointer (e.g., a finger) on the touch surface 110 formed therein. The processing unit 13 stores the pixelated data of the first image in the memory unit 14. The first image contains at least one object image.

In Step S520, the processing unit 13 generates a first light distribution curve according to the first image.

In Step S530, the processing unit 13 defines a first left boundary LB1 and a first right left boundary LB1 in the first light distribution curve by comparing the first light distribution curve (e.g., curve C30 of FIG. 3A or curve C30′ of FIG. 3B) with the aforementioned background light distribution curve (e.g., curve C10 of FIG. 2) or the aforementioned predetermined brightness threshold curve (e.g., curve C20 of FIG. 2), to define a first detection region. The first detection region corresponds to the image position of the object image formed in the first image.

In Step S540, the processing unit 13 obtains at least one touch reference value (e.g., the predefined brightness value, the predefined average brightness value, a predefined brightness difference value, and the predefined average brightness difference value) from the lookup table of touch reference values according to the image position of the object image in the first image.

In Step S550, the processing unit 13 compares at least one brightness value in the first detection region of the first light distribution curve with the at least one touch reference value obtained from the lookup table of reference values. In Step S560, the processing unit 13 determines whether the pointer is touching the touch surface 110 of the touch panel 11 or is hovering over the touch surface 110 of the touch panel 11 according to the comparison result.

When the processing unit 13 determines that pointer is touching the touch surface 110 of the touch panel 11 according to the comparison result, the processing unit 13 executes Step S570. On the other hand, when the processing unit 13 determines that pointer is hovering over the touch surface 110 of the touch panel 11 according to the comparison result, the processing unit 13 executes Step S580.

In Step S570, the processing unit 13 computes a touch position of the pointer relative to the touch surface 110 according to the image position of the object image formed corresponding to the pointer in the first image upon determining that the pointer is touching the touch surface 110 and executes Step S590 thereafter.

In Step S580, the processing unit 13 does not compute the touch position of the pointer relative to the touch surface 110 upon determining that the pointer is hovering over the touch surface 110 and does not output the associated cursor parameter to hold the current display position of the cursor 161 displayed on the display apparatus 16.

In Step S590, the processing unit 13 drives the transmission unit 15 to transmit the cursor parameter information (including the resolution of the touch surface 110) of the touch position to the display apparatus 16 and to correspondingly control the operation of the cursor 161 displayed on the screen of the display apparatus 16, e.g., controlling the movement of the cursor 161.

Next, a number of specific embodiments are provided herein to illustrate algorithms used by the processing unit 13 in determining whether the pointer is touching or hovering over the touch surface 110.

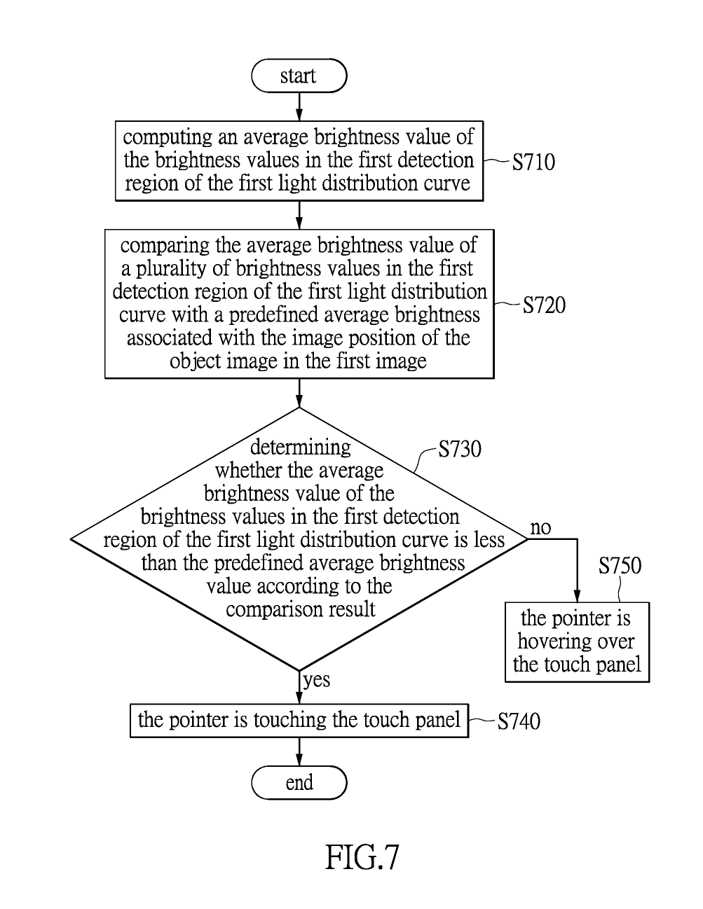

Please refer to FIG. 6 in conjunction with FIG. 3A and FIG. 3B. FIG. 6 shows a flowchart diagram illustrating an object detection method of an optical touch system provided in accordance to another exemplary embodiment of the present disclosure.

In Step S610, the processing unit 16 compares the minimum brightness value of a plurality of brightness values (i.e., the K brightness values) in the first detection region of the first light distribution curve with a predefined brightness value obtained from the lookup table of touch reference values, wherein the predefined brightness value is obtained based on the image position of the object image in the first image.

In Step S620, the processing unit 13 determines whether the minimum brightness of the brightness values in the first detection region of the first light distribution curve is less than the predefined brightness value according to the comparison result.

When the comparison result shows that the minimum brightness of the brightness values in the first detection region of the first light distribution curve is less than the predefined brightness value, the processing unit 13 executes Step S630. When the comparison result shows that the minimum brightness of the brightness values in the first detection region of the first light distribution curve is greater than or equal to the predefined brightness value, the processing unit 13 executes Step S640.

When the first light distribution curve takes form of curve C30 shown in FIG. 3A, the minimum brightness of the brightness values in the first detection region of the first light distribution curve will be less than the predefined brightness value and the processing unit 13 executes Step S630, i.e., the processing unit 13 determines that the pointer is touching the touch surface 110 of touch panel 11. When the first light distribution curve takes the form of curve C30′ shown in FIG. 3B, the minimum brightness of the brightness values in the first detection region of the first light distribution curve will be greater than or equal to the predefined brightness value and the processing unit 13 therefore executes Step S640, i.e., the processing unit 13 determines that the pointer is hovering over the touch surface 110 of touch panel 11.

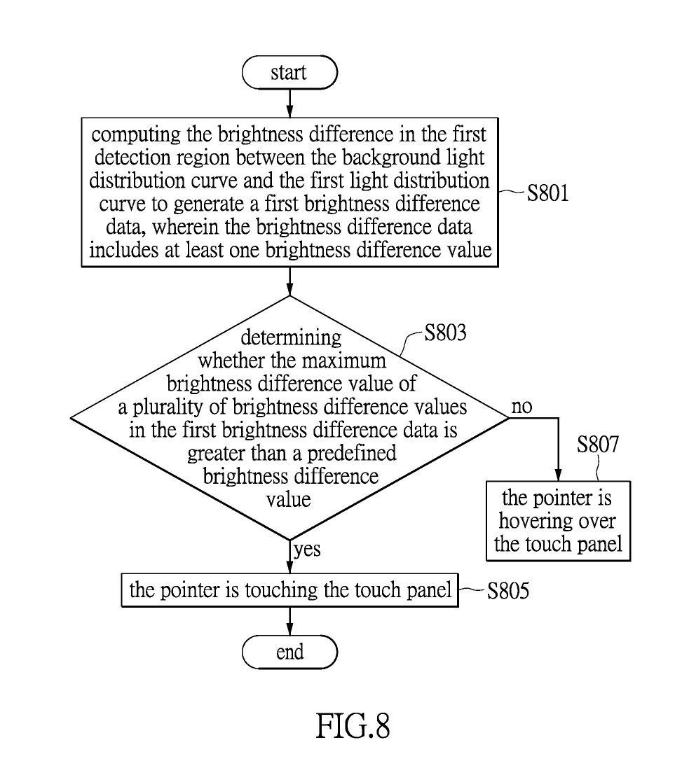

Next, please refer to FIG. 7 in conjunction with FIG. 3A and FIG. 3B. FIG. 7 shows a flowchart diagram illustrating an object detection method of an optical touch system provided in accordance to another exemplary embodiment of the present disclosure.

In Step S710, the processing unit 13 computes an average brightness value of the brightness values (i.e. the K brightness values) in the first detection region of the first light distribution curve. In Step S720, the processing unit 13 compares the average brightness value of the brightness values in the first detection region with a predefined average brightness value obtained from the lookup table of touch reference values, wherein the predefined average brightness value is obtained based on the image position of the object image formed in the first image.

In Step S730, the processing unit 13 determines whether the average brightness value of the brightness values in the first detection region of the first light distribution curve is less than the predefined average brightness value according to the comparison result.

When the comparison result shows that the average brightness value of the brightness values in the first detection region of the first light distribution curve is less than the predefined average brightness value, the processing unit 13 executes Step S740. On the other hand, when the comparison result shows that the average brightness value of the brightness values in the first detection region of the first light distribution curve is greater than or equal to the predefined average brightness value, the processing unit 13 executes Step S750.

When the first light distribution curve takes form of curve C30 shown in FIG. 3A, the minimum brightness of the brightness values in the first detection region of the first light distribution curve will be less than the predefined average brightness value and the processing unit 13 executes Step S740 i.e., the processing unit 13 determines that the pointer is touching the touch surface 110 of touch panel 11. When the first light distribution curve takes form of curve C30′ shown in FIG. 3B, the minimum brightness of the brightness values in the first detection region of the first light distribution curve will be greater than or equal to the predefined brightness value and the processing unit 13 therefore executes Step S750 i.e., the processing unit 13 determines that the pointer is hovering over the touch surface 110 of touch panel 11.

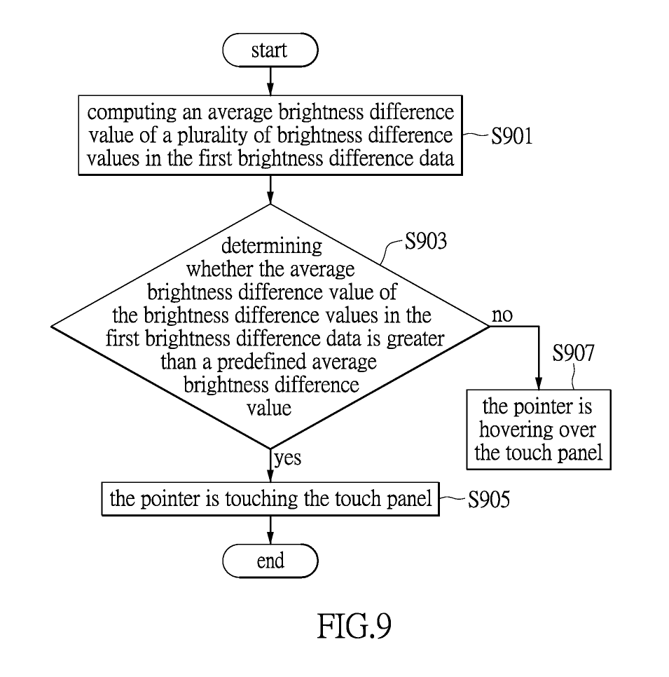

Please refer to FIG. 8 in conjunction with FIG. 4, wherein FIG. 8 shows a flowchart diagram illustrating an object detection method of an optical touch system provided in accordance to another exemplary embodiment of the present disclosure.

In Step S801, the processing unit 13 computes the brightness difference in the first detection region between the background light distribution curve (i.e. curve C10) and the first light distribution curve (i.e. curve C30 or C30′) and generates a first brightness difference data. The first brightness difference data includes at least one brightness difference value. To put it concretely, the processing unit 13 computes the brightness difference (e.g., P_TPn−P_BGn|)| between the brightness values P_TP1˜TPK of the first light distribution curve (i.e., curve C30) and the respective brightness values P_BG1˜P_BGK of the background light distribution curve (i.e. curve C10) to generate the first brightness difference data, wherein n is an integer lying between 1 and K.

In Step S803, the processing unit 13 determines whether the maximum brightness difference value of a plurality of brightness difference values in the first brightness difference data is greater than a predefined brightness difference value, wherein the predefined brightness difference value is obtained from the lookup table of touch reference values based on the image position of the object image formed in the first image.

When the processing unit 13 determines that the maximum brightness difference value of the plurality of brightness difference values in the first brightness difference data is greater than the predefined brightness difference value, the processing unit 13 executes Step S805; otherwise, the processing unit 13 executes Step S807.

In Step S805, the processing unit 13 determines that the pointer is touching the touch surface 110 of the touch panel 11. In Step S807, the processing unit 13 determines that the pointer is hovering over the touch surface 110 of the touch panel 11.

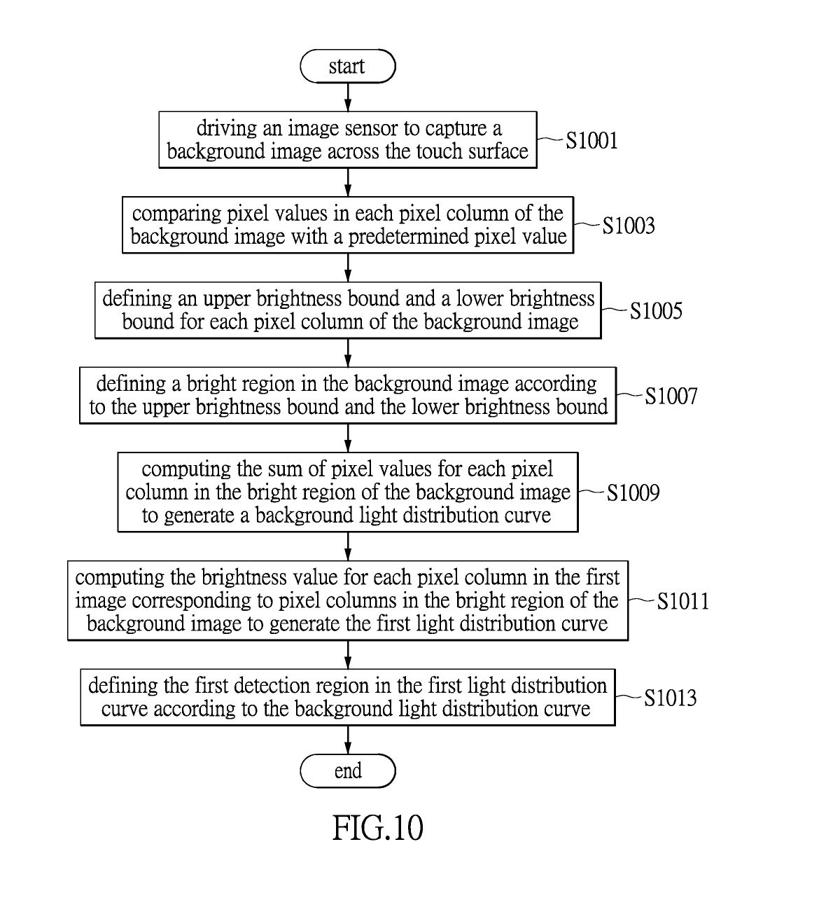

Next, please refer to FIG. 9, which shows a flowchart diagram illustrating an object detection method of an optical touch system provided in accordance to further another exemplary embodiment of the present disclosure.

In Step S901, the processing unit 13 computes an average brightness difference value of a plurality of brightness difference values in the first brightness difference data.

In Step S903, the processing unit 13 determines whether the average brightness difference value of the plurality of brightness difference values in the first brightness difference data is greater than a predefined average brightness difference value, wherein the predefined average brightness difference value is obtained from the lookup table of touch reference values based on the image position of the object image formed in the first image.

When the processing unit 13 determines that the average brightness difference value of the brightness difference values in the first brightness difference data is greater than the predefined average brightness difference value, the processing unit 13 executes Step S905; otherwise, the processing unit 13 executes Step S907.

In Step S905, the processing unit 13 determines that the pointer is touching the touch surface 110 of the touch panel 11. In Step S907, the processing unit 13 determines that the pointer is hovering over the touch surface 110 of the touch panel 11.

The steps depicted in FIG. 6˜FIG. 9 can be executed by the processing unit 13 while executing Step S550. The object detection method depicted in FIG. 5 and the object detection method employed for detecting and analyzing an object image formed in a first image captured depicted in FIG. 6˜FIG. 9 can be implemented by writing the corresponding program codes into the processing unit 13 (which can be implemented by a processing chip or a micro-controller) via firmware design, so that the processing unit 13 can execute at least one of the brightness analyzing algorithms depicted in FIG. 6˜FIG. 9 or a combination thereof during the execution of Step S550, however the present disclosure is not limited to thereto. Moreover, in practice, the processing unit 13 may also sequentially execute methods for determining the touch state of the pointer depicted in FIG. 6˜FIG. 9 during the execution of Step S550 in FIG. 5. It should be noted that FIG. 5˜FIG. 9 are merely used for illustrating the implementation method of the object detection method and the present disclosure is not limited thereto.

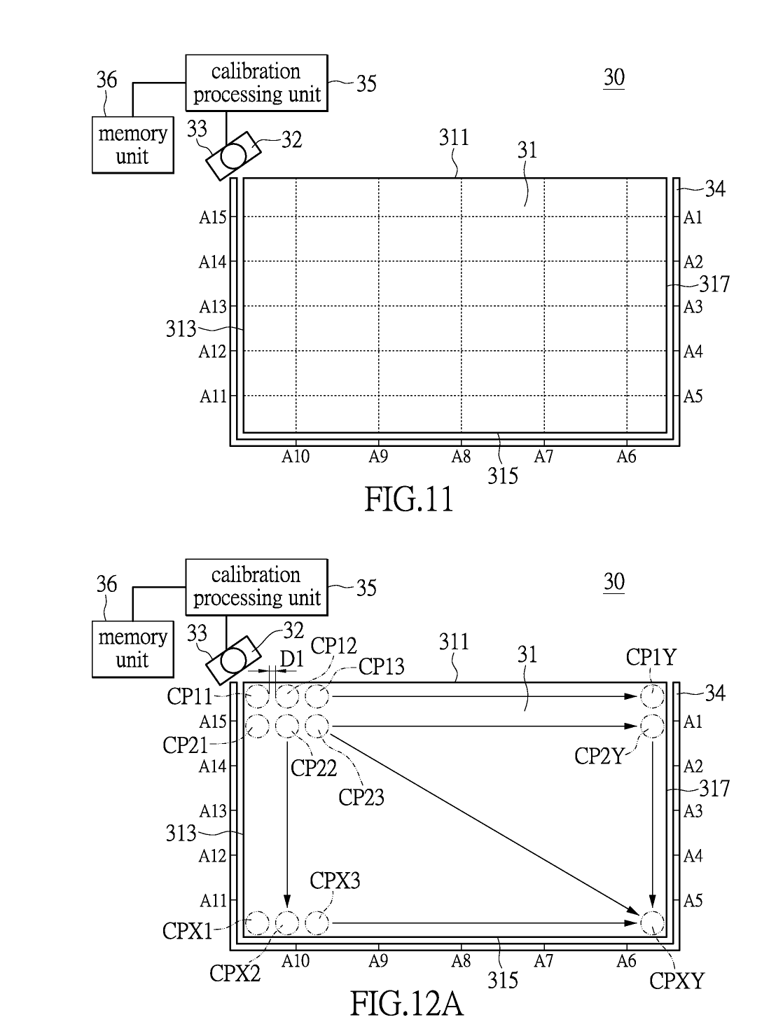

The present disclosure further provides the method for defining the bright region of the light distribution cure and the generation method of the background light distribution curve data. Please refer to FIG. 10 in conjunction with FIG. 1 and FIG. 2. FIG. 10 shows a flowchart diagram illustrating the method for defining the first detection region provided in accordance to another exemplary embodiment of the present disclosure.

In Step S1001, the processing unit 13 drives the image sensor 12 to capture a background image FB across the touch surface 110 before the pointer approaches or enters the touch sensing region TR (e.g., at the startup of the optical touch system 1). The background image FB includes at least a background region DR and a bright region DR.

In Step S1003, the processing unit 13 compares each pixel value in each pixel column of the background image FB with a predetermined pixel value. The predetermined pixel value as previously described may be configured according to the average brightness of the background image FB and a preset weighting factor α1 (e.g., 1.2). The preset weighting factor α1 may be configured according to the practical operation requirements (such as the image sensing capability of the image sensor 12 or the ambient light) of the optical touch system 1. The processing unit 13 may also configure the predetermined pixel value for each pixel column according to the average pixel value of each respective pixel column and a preset weighting factor, however the instant embodiment is not limited thereto.

In Step S1005, the processing unit 13 defines an upper brightness bound H_UB and a lower brightness bound H_LB for each pixel column of the background image FB. At least one pixel lies between the upper brightness bound H_UB and the lower brightness bound H_LB, wherein the pixel value of the at least one pixel value is greater than the predetermined pixel value.

The processing unit 13 may first compare the pixel value of each pixel of each pixel column in the background image FB with the predetermined pixel value and define the upper brightness bound H_UB and the lower brightness bound H_LB for each pixel column thereafter based on the area in each respective pixel column having the most number of pixels with a pixel value greater than the predetermined pixel value.

In Step S1007, the processing unit 13 defines the bright region in the background image FB according to the upper brightness bound H_UB and the lower brightness bound H_LB.

In Step S1009, the processing unit 13 generates the background light distribution curve (i.e., curve C10) by summing the pixel values of the pixels in each pixel column inside the bright region of the background image FB. The processing unit 13 further stores curve data of the background light distributing curve in the memory unit 14. As described previously, the processing unit 13 further generates a predetermined brightness threshold curve (i.e. curve C10) with lower brightness according to a preset brightness weighting factor α2 (e.g., 0.2) for providing appropriate brightness tolerance. The processing unit 13 stores curve data of the predetermined brightness threshold in the memory unit 14 serving as the basis for determining the image position of the object image in the first image, so as to eliminate discrepancies generated by the image sensor 12 due to surrounding noise.

In Step S1011, the processing unit 13 computes the brightness value for each pixel column in the first image corresponding to pixel columns in the bright region of the background image to generate the first light distribution curve. In Step S1013, the processing unit 13 defines the first detection region in the first light distribution curve according to the background light distribution curve. In the instant embodiment, the processing unit 13 compares the brightness values of the first light distribution curve with the brightness value of the predetermined brightness threshold curve associated with the background light distribution curve and defines a first left boundary LB1 and the first right boundary RB1 in the first light distribution curve thereafter to define the first detection region in the first light distribution curve.

The method for defining the first detection region in the first light distribution curve depicted in FIG. 10 may be also implemented by writing the corresponding program codes into a process chip configured as the processing unit 13 via firmware design. It shall be noted that FIG. 10 is merely used for illustrating an implementation of defining the first detection region in the first light distribution curve, defining the bright region as well as generating background light distribution curve data, and the present disclosure is not limited thereto.

(An Exemplary Embodiment of a Calibration Apparatus for an Optical Touch System)

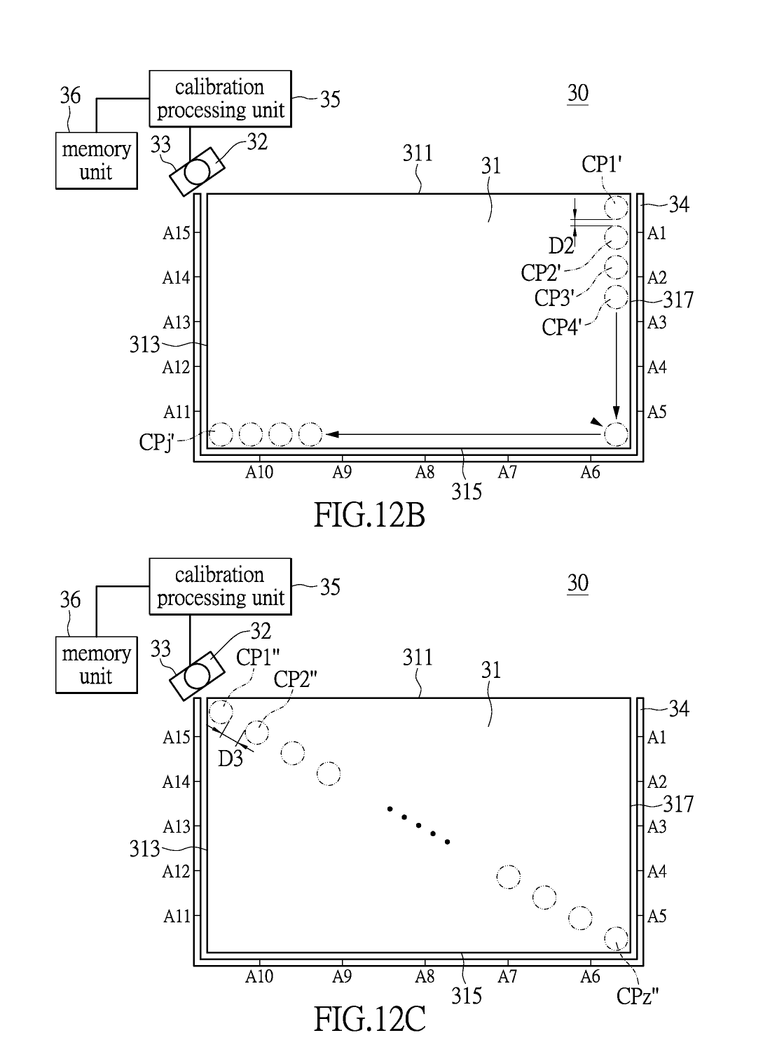

The present disclosure further provides a calibration apparatus for the aforementioned optical touch system, which is used to calibrate the optical touch system before factory shipment and generate a lookup table of touch reference values. Please refer to FIG. 11 in conjunction with FIG. 1, wherein FIG. 11 shows a diagram of a calibration apparatus of an optical touch system provided in accordance to an exemplary embodiment of the present disclosure. A calibration apparatus 30 includes a touch panel 31, a first image sensor 32, a light-emitting component 33, an auxiliary reference device 34, a calibration processing unit 35, and a memory unit 36. The touch panel 31, a first image sensor 32, the light-emitting component 33, and the memory unit 36 are respectively coupled to the calibration processing unit 35. The touch panel 31 includes a first side 311, a second side 313, a third side 315 opposite to the first side 311, and a fourth side 317 opposite to the second side 313. The first side 311 and the third side 315 are connected through the second side 313 and the fourth side 317, respectively. The first image sensor 32 is disposed at the corner intersected by the first and the second sides 311, 313. The first image sensor 32 is configured to capture images across the touch panel 31 and provide images to the calibration processing unit 35 to analyze the position of the calibrations point and the brightness information thereof. The image sensing area of the first image sensor 32 at least encompasses the second side 313 and the third side 315 of the touch panel 31. The light-emitting component 33 is integrated on the first image sensor 32 and is configured to light the touch panel 31, i.e., generate a light illuminating the touch panel 31.

The auxiliary reference device 34 comprises a plurality of reference marks A1˜A15. The reference marks A1˜A15 are placed or labeled on an auxiliary frame. The reference marks A1˜A15 includes a first set of reference marks (i.e., the reference marks A1˜A5), a second set of reference marks (i.e., the reference marks A6˜A10), and a third set of reference marks (i.e., the reference marks A11˜A15).

When the auxiliary reference device 34 is placed on top of the touch panel 31, the first set of reference marks (i.e., the reference marks A1˜A5) is positioned on the fourth side 317 of the touch panel 31, the second set of reference marks (i.e., the reference marks A6˜A10) is positioned on the third side 315, and the third set of reference marks (i.e., the reference marks A11˜A15) is positioned on the second side 313 of the touch panel 31.

The number of reference marks used by the auxiliary reference device 34 and the number of reference marks in each set of reference marks may be configured according to the exact structure and the practical operation requirement of the calibration apparatus 30 and the present disclosure is not limited to the auxiliary reference device 34 depicted in FIG. 11.

The calibration processing unit 35 is configured to execute a calibration program to generate the lookup table of reference values. During the execution of the calibration program, a plurality of calibration objects is sequentially disposed on the touch panel 31 The calibration processing unit 35 operatively drives the first image sensor 32 to capture a plurality of first calibration images corresponding to the respective calibration objects disposed on the touch panel 31 and the reference marks A1˜A15. Next, the calibration processing unit 35 obtains a plurality of touch reference values associated with the calibration object images of the calibration objects by analyzing the first calibration images captured. In the instant embodiment, the positions of the calibration objects relative to the touch panel 31 are known.

More specifically, the calibration processing unit 35 correspondingly transforms the first calibration images into a plurality of the calibration light distribution curves. Then, the calibration processing unit 35 analyzes the brightness information of the first detection region of each calibration light distribution curve according to the background light distribution curve, such as the minimum brightness value and the average brightness value of the first detection region of each respective calibration light distribution curve, the maximum brightness difference value and the average brightness difference value of the first detection region between the background light distribution curve and each respective calibration light distribution curve. The calibration processing unit 35 correspondingly generates a plurality of touch reference values associated with the object images formed in correspondence to the calibration objects in the first calibration images according to the minimum brightness value, the average brightness value, the maximum brightness difference value, and the average brightness difference value associated with each of the first detection regions of each respective calibration light distribution curve and a weighting factor α3 thereafter. The weighting factor α3 may be configured according to the average touch depth of calibration objects touching the touch panel 31 and/or the sensitivity of the first image sensor 32, and the instant embodiment is not limited thereto.

The calibration processing unit 35 further computes the position of each calibration object relative to the touch panel 31 according to the image position of each object image and the reference marks A1˜A15 formed in each respective first calibration image. The calibration processing unit 35 subsequently generates (or establishes) the lookup table of touch reference values according to the position of each of the calibration objects relative to the touch panel 31 and the associated touch reference values.

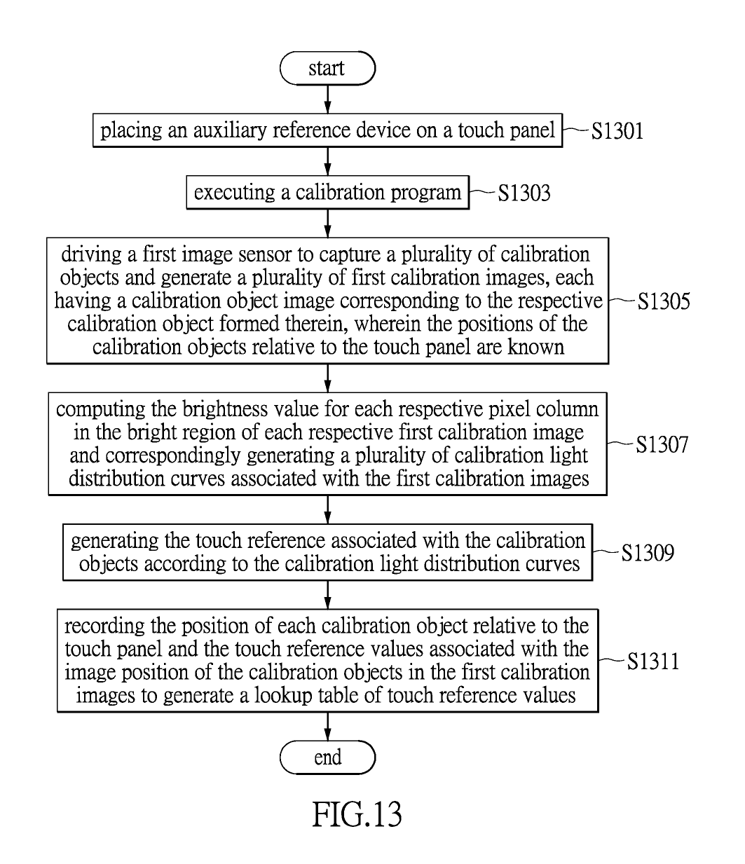

The calibration objects may be disposed on the touch panel 31 as described in FIG. 12A˜FIG. 12C. FIG. 12A˜FIG. 12C shown schematic diagrams respectively illustrating the disposition of calibration objects provided in accordance to an exemplary embodiment of the present disclosure.

As shown in FIG. 12A, the calibration objects may each be sequentially disposed in an array on the touch panel 31 along the first side 311, the second side 313, the third side 315, and the fourth side 317 of the touch panel 31 forming a plurality of calibration points CP11˜CPXY, wherein X and Y are integers. The calibration objects are equally spaced (e.g., spaced for a distance D1) and disposed on the touch panel 31. The calibration objects may also each be sequentially disposed on the touch panel 31 along the sidewall of the third side 315 and the fourth side 317 forming a plurality of calibration points CP1′˜CPj′ as illustrated in FIG. 12B, wherein j is an integer. The calibration objects are equally spaced (e.g., spaced for a distance D2) and disposed on the touch panel 31. The calibration objects may also each be sequentially disposed on the touch panel 31 along a diagonal direction of the touch panel 31 forming a plurality of calibration points CP1″˜CPz″ as illustrated in FIG. 12C, wherein z is an integer. The calibration objects are equally spaced (e.g., spaced for a distance D3) and disposed on the touch panel 31. The distances D1, D2, and D3 may each be set according to the precision required for building the lookup table of reference values, the number of calibration objects disposed, and the exact structure of the calibration apparatus 30.

It shall be noted that the exact placement method of the calibration objects utilized and the number of calibration objects disposed on the touch panel 31 may be determined according to the exact structure of the calibration apparatus 30 (e.g., the number of reference marks placed) or the calibration requirements, and the present disclosure is not limited thereto. The more number of the calibration objects deployed on the touch panel 31 or the more close the position of the calibration object deployed is close to the image forming positions on the touch panel 31 (e.g., the fourth side 317 of touch panel 31), the more accurate the touch reference values computed are and the more precise the position of the calibration points computed are. In a preferably embodiment, the placements of the calibration objects should at least cover positions corresponding to the reference marks marked on the fourth side 317 of the touch panel 31, so that the calibration processing unit 35 (or the processing unit 13 of the aforementioned optical touch system 1) can use the interpolation method to compute the touch reference value associated with the touch position of the pointer relative to the touch surface 110 of the aforementioned optical touch system 1 based on the positions of the calibration points recorded in the lookup table of touch reference values.

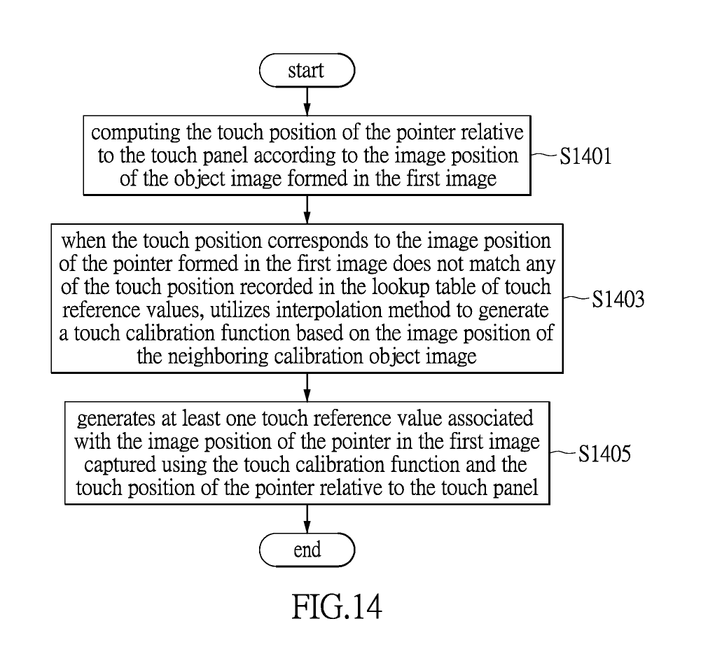

The instant embodiment further generalizes a calibration method executed by the calibration apparatus 30 during the calibration of the optical touch system. Please refer to FIG. 13 in conjunction with FIG. 11, wherein FIG. 13 shows a flowchart diagram illustrating a calibration method for the aforementioned optical touch system provided in accordance to an exemplary embodiment of the present disclosure.

In Step S1301, the auxiliary reference device 34 is first placed on the touch panel 31 in a manner that the first set of reference marks (i.e., reference marks A1˜A5) is positioned at the fourth side 317 of the touch panel 31, the second set of reference marks (i.e., reference marks A6˜A10) is positioned at the third side 315 of the touch panel 31, and the third set of reference marks (i.e., reference marks A11˜A15) is positioned at the second side 313 of the touch panel 31.

In Step S1303, the calibration processing unit 35 executes a calibration program. In Step S1305, the calibration processing unit 35 drives the light-emitting component 33 to illuminate the touch panel 31 while drives the first image sensor 32 to capture a plurality of calibration objects and generates a plurality of first calibration images, each having a calibration object image corresponding to the respective calibration object formed therein. The position of each calibration object relative to the touch panel 31 is known.

In Step S1307, the calibration processing unit 35 generates a calibration light distribution curve for each respective calibration image captured by computing the brightness value for each respective pixel column in the bright region of each respective calibration image. The generation method of the calibration light distribution curves of the calibration images is the same as the generation method of the first light distribution curve described previously, hence further description are hereby omitted.

In Step S1309, the calibration processing unit 35 generates a plurality of touch reference values associated with the image position of the calibration object images formed in the first calibration images according to the calibration light distribution curves obtained. More specifically, the calibration processing unit 35 may compute the plurality of touch reference values associated with the image positions of calibration object images formed in the respective first calibration images according to the calibration light distribution curves, the background light distribution curve and a weighting factor α3.

In Step S1311, the calibration processing unit 35 records the position of each calibration object relative to the touch panel 31 and the touch reference values associated with the image position of the calibration objects in the first calibration images and generates the lookup table of touch reference values. The lookup table of touch reference values contains at least one touch reference value associated with the image position of each calibration object in the respective first calibration image. The touch reference values herein represent the brightness information associated with the calibration object images of the calibration objects formed in the first calibration image, and comprise at least one of at least one of a predefined brightness value, a predefined average brightness value, a predefined brightness difference value, and a predefined average brightness difference value.

Incidentally, the calibration apparatus 30 may further include a second image sensor (not shown) coupled to the calibration processing unit 35 to increase the precision and the accuracy of the lookup table of touch reference values. The second image sensor may be disposed (or placed) at the intersection formed between the first side 311 and the fourth side 317 or at the intersection formed between the third side 315 and the fourth side 317 opposite to the first image sensor 32. The second image sensor and the first image sensor 32 may be respectively disposed at different locations on the touch panel 31 and configured to have overlapping sensing area. The second image sensor can be configured to capture the calibration objects and the reference marks, and generate the plurality of second calibration images. The calibration processing unit 35 may obtain the touch reference values associated with the image positions of the calibration objects (i.e., the calibration objects images) formed in the second calibration images according to the second calibration images and establish a second lookup table of touch reference values for the second image sensor. The second lookup table of touch reference values records the image position of each calibration object formed in each of the respective second calibration images and the associated touch reference values.

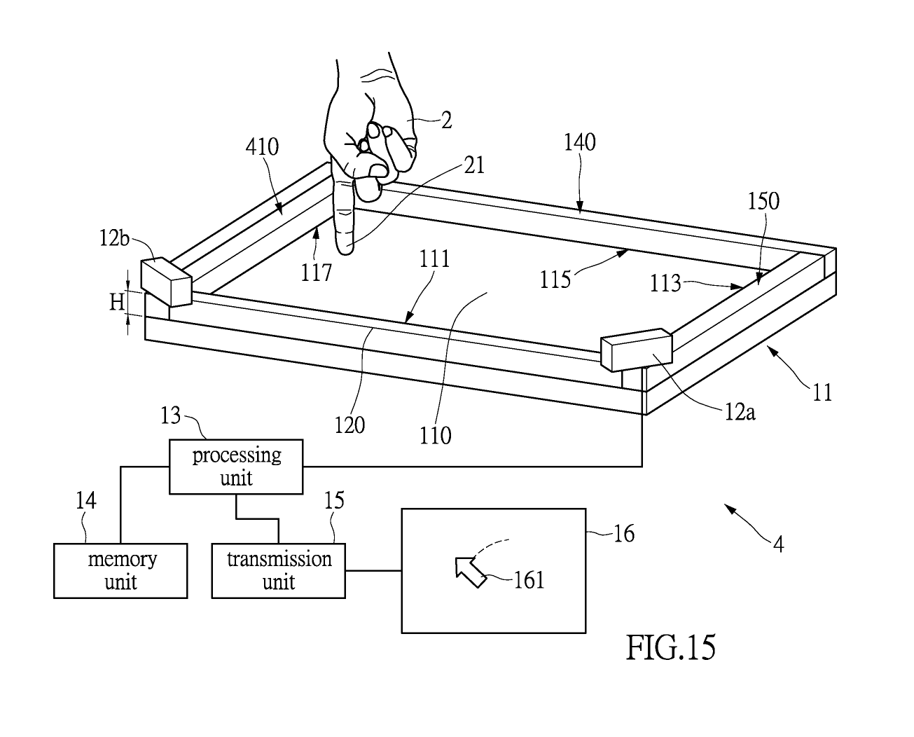

Next, an implementation method of obtaining the touch reference values associated with the image position of the pointer in the image captured using the lookup table of touch reference values is provided. Please refer to FIG. 14 in conjunction with FIG. 1, wherein FIG. 14 shows a flowchart diagram illustrating a method of obtaining touch reference values provided in accordance to another exemplary embodiment of the present disclosure.

In Step S1401, the processing unit 13 of the optical touch system 1 computes the touch position of the pointer relative to the touch panel 11 according to the image position of the object image corresponding to the pointer formed in the first image captured during the operation of the optical touch system 1

In Step S1403, when the touch position associated with the image position of the pointer in the first image does not match any of the touch positions recorded in the lookup table of touch reference values, the processing unit 13 of the optical touch system 1 generates a touch calibration function using the interpolation method based on the image position of the neighboring calibration object image. The processing unit 13 may generate the touch calibration function that corresponds to at least one of the predefined brightness value, the predefined average brightness value, the predefined brightness difference value, and the predefined average brightness difference value based on the image position of each calibration object image formed in each respective first calibration image captured.

In Step S1405, the processing unit 13 of the optical touch system 1 computes at least one touch reference value (including the predefined brightness value, the predefined average brightness value, the predefined brightness difference value, and the predefined average brightness difference value) associated with the image position of the pointer in the first image captured according to the touch calibration function and the touch position of the pointer relative to the touch panel 31 of the calibration apparatus 30 (shown in FIG. 11). The processing unit 13 of the optical touch system 1 determines whether the pointer is touching the touch panel 11 according to the computation result.

Accordingly, during the operation of the optical touch system 1, the processing unit 13 can analyze and determine whether the pointer is touching the touch panel 11 of the optical touch system 1 or is hovering over the touch panel 11 according to the lookup table of touch reference values associated with the first image sensor 31 and/or the second lookup table of touch reference values associated with the second image sensor pre-stored in the memory unit 14 of the optical touch system 1.

(Another Embodiment of the Optical Touch System)

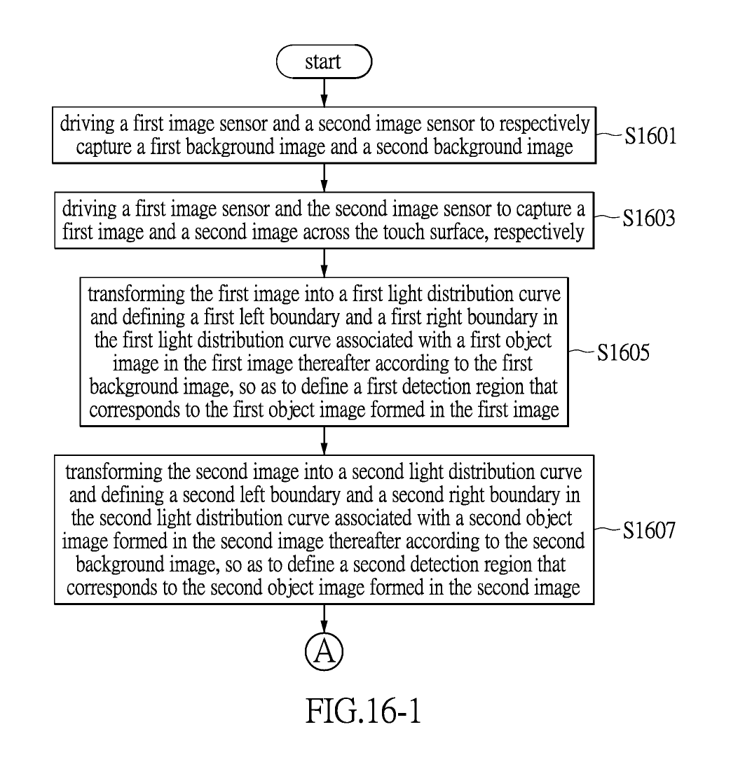

Please refer to FIG. 15, which shows a diagram of an optical touch system provided in accordance to another exemplary embodiment of the present disclosure.

The difference between an optical touch system 4 of FIG. 15 and the optical touch system 1 of FIG. 1 is that the optical touch system 4 includes two image sensors, i.e., a first image sensor 12a and a second image sensor 12b, to prevent the occurrence of false detection issues due to the dead zone or blind spots associated with the position of a single image sensor or the position of the light emitting component. Moreover, the optical touch system 4 uses a third reflecting unit 410 in place of the reflective mirror 130 of FIG. 1. The region surrounded by the touch surface 110, the light-emitting component 120, the first reflecting unit 140, the second reflecting unit 150, and the third reflecting unit 410 forms a touch sensing region TR of the optical touch system 4. The touch sensing region TR of the optical touch system 4 has a height H, wherein the height H may be configured based on the exact structure of the optical touch system 4 and the operation requirement thereof.

More specifically, the first image sensor 12a is disposed at a first corner formed between the first side 111 of the touch panel 11 and the second side 113 of the touch panel 11. The second image sensor 12b is disposed at a second corner formed between the first side 111 of the touch panel 11 and the fourth side 117 of the touch panel 11. The first image sensor 12a and the second image sensor 12b are respectively disposed at different locations on the touch panel 11. The sensing area of the first image sensor 12a and the sensing area of the second image sensor 12b are configured to be overlapped, so as to enhance the touch recognition rate of the optical touch system 4.

The first image sensor 12a and the second image sensor 12b respectively capture images across the touch surface 110 and may or may not include the touch surface 110. In the instant embodiment, the touch surface 110 is a non-reflecting surface, and images captured by the first image sensor 12a and the second image sensor 12b across the touch surface 110 include only the region surrounded by the first reflecting unit 140, the second reflecting unit 150, and the third reflecting unit 410, and does not include the mirror image reflected from the touch surface 110. The longitudinal field of view of the first and the second image sensors 12a, 12b are preferably configured to be larger than the height of the touch sensing region TR for completely capturing the image of the pointer.

Briefly, the processing unit 13 may respectively drive the first image sensor 12a and the second image sensor 12b to capture a plurality of images across the touch surface 110 according to a predetermined frame rate. The processing unit 13 operatively detects whether the pointer is touching the touch surface 110 or is hovering over the touch surface 110 according to the sensing results of the first and the second image sensors 12a, 12b.

When the sensing result of the first image sensor 12a and the sensing result of the second image sensor 12b simultaneously indicate that the pointer is touching the touch surface 110, the processing unit 13 determines that the pointer is touching the touch surface 110. When the sensing result of either the first image sensor 12a or the second image sensor 12b indicates that the pointer is hovering over the touch surface 110, the processing unit 13 determines that the pointer is hovering over the touch surface 110.

When the processing unit 13 determines that the pointer is touching the touch surface 110, the processing unit 13 computes a touch position of the pointer (e.g., the finger 21) relative to the touch surface 110 according to the image position of the pointer formed the first image and the image position of the pointer formed in the second image. The processing unit 13 further drives the transmission unit 15 to transmit the coordinate information of the touch position to the display apparatus 16 to correspondingly control the operation of the cursor 161 displayed on the display apparatus 16.

In order to clearly understand the operation of the optical touch system 4, the instant embodiment further discloses an object detection method for the optical touch system 4. Please refer to FIG. 16-1 and FIG. 16-2 in conjunction with FIG. 15, wherein FIG. 16-1 and FIG. 16-2 are flowchart diagrams illustrating an object detection method of an optical touch system provided in accordance to an exemplary embodiment of the present disclosure.

The memory unit 14 of the optical touch system 4 is configured to pre-store a first lookup table of touch reference values and a second lookup table of touch reference values. The first lookup table of touch reference values records a plurality of touch reference values associated with the image positions of the object images (which correspond to the calibration objects) formed in the calibration images captured by the first image sensor 12a. The second lookup table of touch reference values records a plurality of touch reference values associated with the image positions of the object images (which correspond to the calibration objects) formed in the calibration images captured by the second image sensor 12b. The first lookup table of touch reference values and the second lookup table of touch reference values records at least one touch reference value associated with the image position of each calibration object image formed in each respective calibration image captured. The touch reference values may represent the brightness information associated with the image positions of the calibration object image in the images captured by the first and the second image sensors, and include at least one of a predefined brightness value, a predefined average brightness value, a predefined brightness difference value, and a predefined average brightness difference value.

The first and the second lookup tables of touch reference values may be generated by performing a calibration program with a calibration apparatus having the image sensor positioned on the touch panel the same as the first or the second image sensor and pre-stored in the memory unit 14 before factory shipment of the optical touch system 4.

In Step S1601, the processing unit 13 drives the first image sensor 12a and the second image sensor 12b to respectively capture a first background image (not shown) and a second background image (not shown) across the touch surface 110 of the touch panel 11 before a pointer enters the touch sensing region TR, such as at the startup of the optical touch system 4 or before the detection of the presence of the pointer (e.g., the finger 21 of the user 2). The processing unit 13 then respectively transforms a first background image and a second background image into a first light distribution curve and a second light distribution curve, respectively.

In Step S1603, the processing unit 13 respectively drives a first image sensor 12a and the second image sensor 12b to capture a first image and a second image across the touch surface 110.

In Step S1605, the processing unit 13 transforms the first image into a first light distribution curve and defines a first left boundary and a first right boundary associated with a first object image thereafter in the first light distribution curve according to the first background image, so as to define a first detection region that corresponds to the first object image of the pointer formed in the first image.

In Step S1607, the processing unit 13 transforms the second image into a second light distribution curve and defines a second left boundary and a second right boundary associated with a second object image in the second light distribution curve that corresponds thereafter according to the second background image, so as to define a second detection region that corresponds to the second object image of the pointer formed in the second image.

In Step S1609, the processing unit 13 determines whether the pointer is touching the touch surface 110 of the touch panel 11 or is hovering over the touch surface 110 according to a plurality of brightness values of the first detection region and a plurality of brightness values of the second detection region. To put it concretely, the processing unit 13 determines whether the pointer is touching the touch surface 110 of the touch panel 11 or is hovering over the touch surface 10 by respectively comparing the brightness values in the first detection region of the first light distribution curve with at least one touch reference value associated with the image position of the first object image in the first image recorded in the first lookup table of touch reference values and the brightness values in the second detection region of the second light distribution curve with at least one touch reference value associated with the image position of the second object image in the second image recorded in the second lookup table of touch reference values. Particularly, the processing unit 13 can determine whether the pointer is touching the touch surface 110 of the touch panel 11 or is hovering over the touch surface 110 by executing at least one object detection method depicted in FIG. 6˜FIG. 9 or by sequentially executing the object detection methods depicted in FIG. 6, FIG. 7, FIG. 8, and FIG. 9.

More specifically, the processing unit 13 determines whether the object image of the pointer formed in the first image indicates that the pointer is touching or hovering over the touch surface by comparing the minimum brightness value of the first detection region with the corresponding predefined brightness value recorded in the first lookup table of touch reference values, the average brightness value of the first detection region with the corresponding predefined average brightness value recorded in the first lookup table of touch reference values, the maximum brightness difference value of a first brightness difference data with the corresponding predefined brightness difference value recorded in the first lookup table of touch reference values, and/or the average brightness difference value of the first brightness difference data with the corresponding predefined average brightness difference value recorded in the first lookup table of touch reference values. The processing unit 13 further can obtain the first brightness difference data by computing the difference between each brightness value in the first detection region with each respective brightness value of the first background light distribution curve.

The processing unit 13 further determines whether the object image of the pointer formed in the second image indicates that the pointer is touching or hovering over the touch surface by comparing the minimum brightness value of the second detection region with the corresponding predefined brightness value recorded in the second lookup table of touch reference values, the average brightness value of the second detection region with the corresponding predefined average brightness value recorded in the second lookup table of touch reference values, the maximum brightness difference value of a second brightness difference data with the corresponding predefined brightness difference value recorded in the second lookup table of touch reference values, and/or the average brightness difference value of the second brightness difference data with the corresponding predefined average brightness difference value recorded in the second lookup table of touch reference values. Similarly, the processing unit 13 further can obtain the second brightness difference data by computing the difference between each brightness value in the second detection region with each respective brightness value of the second background light distribution curve.

When the minimum brightness value of the first detection region is determined to be less than the corresponding predefined brightness value recorded in the first lookup table of touch reference values, or when the average brightness value of the first detection region is determined to be less than the corresponding predefined average brightness value recorded in the first lookup table of touch reference values, or when the maximum brightness difference value of the first brightness difference data is determined to be greater than the corresponding predefined brightness difference value recorded in the first lookup table of touch reference values, or when the average brightness difference value of the first brightness difference data is determined to be greater than the corresponding predefined average brightness difference value recorded in the first lookup table of touch reference values, this indicates that the sensing result of the first image sensor 12a is showing that the pointer is touching the touch panel 11; otherwise, the sensing result of the first image sensor 12a indicates that the pointer is hovering over the touch panel 11.

Similarly, when the minimum brightness value of the second detection region is determined to be less than the corresponding predefined brightness value recorded in the second lookup table of touch reference values, or when the average brightness value of the second detection region is determined to be less than the corresponding predefined average brightness value recorded in the second lookup table of touch reference values, or when the maximum brightness difference value of the second brightness difference data is determined to be greater than the corresponding predefined brightness difference value recorded in the second lookup table of touch reference values, or when the average brightness difference value of the second brightness difference data is determined to be greater than the corresponding predefined average brightness difference value recorded in the second lookup table of touch reference values, this indicates that the sensing result of the second image sensor 12b is showing that the pointer is touching the touch panel 11; otherwise, the sensing result of the first image sensor 12b indicates that the pointer is hovering over the touch panel 11.

In Step S1611, when the processing unit 13 determines that the brightness values of the first detection region and the brightness values of the second detection region simultaneously indicate that the pointer is touching the touch surface 110, the processing unit 13 determines that the pointer is touching the touch surface 110 and executes Step S1615.

In Step S1613, when either the brightness values of the first detection region or the brightness values of the second detection region indicates that the pointer is hovering over the touch surface 110, the processing unit 13 determines that the pointer is hovering over the touch surface 110 and the processing unit 13 does not compute the touch position of the pointer relative to the touch surface 110.

In Step S1615, the processing unit 13 computes a touch position of the pointer relative to the touch panel 11 according to the image position of the first object image corresponding to the pointer formed in the first image and the image position of the second object image corresponding to the pointer formed in the second image.

The processing unit 13 can also compute the touch coordinate using triangulation technique, and details on the computation of the touch coordinate have been described in the aforementioned embodiments and are known arts in the field, hence further description is hereby omitted.

It is worth to note that the first image sensor 12a and the second image sensor 12b can be each implemented by a charge-coupled device (CCD) image sensor or a complementary metal oxide semiconductor (CMOS) image sensor. Those skilled in the art shall be able to design and implement the first image sensor 12a and the second image sensor 12b according to the practical operation requirements and the instant embodiment is not limited thereto.

Additionally, in order to enhance the reflection effect of the first, the second, and the third reflecting units 140, 150, 410, an additional light-emitting component having similar structure as the light-emitting component 120 can be used and configured to illuminate the touch surface 110. The newly added light-emitting component 120 may be integrated with the first image sensor 12a disposed at the first corner or the second image sensor 12b at the second corner. The newly added light-emitting component 120 may be integrated with the first or the second image sensor 12a, 12b by sticking, screwing, or fastening, so as to fixedly position or mount the light-emitting component 120 on the first image sensor 12a or the second image sensor 12b.

Accordingly, the optical touch system 4 may further enhance the recognition rate of touch point by disposing two additional image sensors. In another embodiment, the optical touch system 4 may also include three, four or more than four image sensors, and these image sensors can be respectively disposed at different locations on the touch surface 110. These image sensors can be configured to have overlapping sensing area to increase touch recognition rate of the optical touch system 4. In other words, the number of the image sensors used in the optical touch system 4 and the corresponding placements can be configured and designed according to the exact structure of and the operation requirement, and the instant embodiment is not limited thereto.

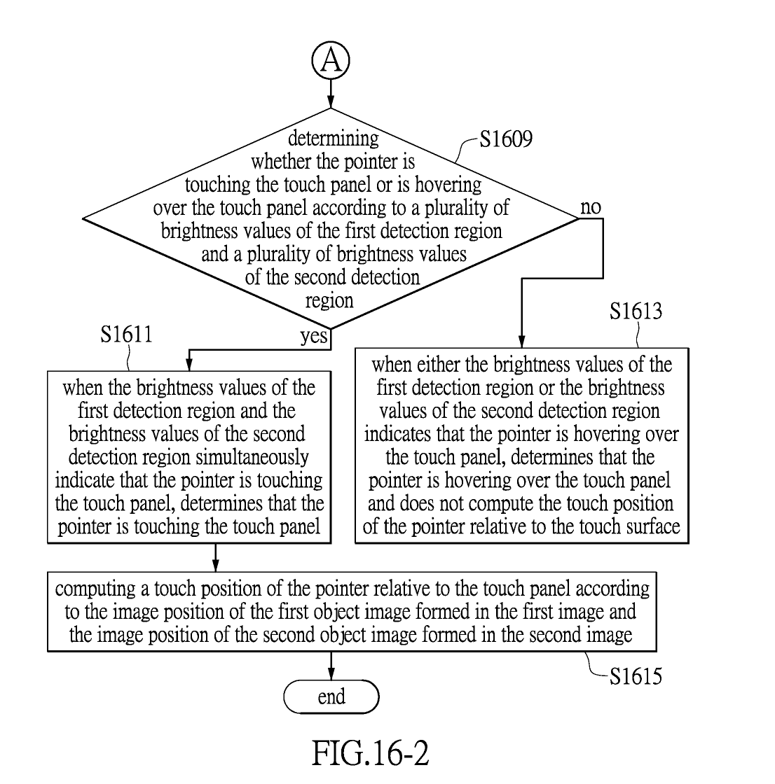

The object detection method depicted in FIG. 16 can be implemented by programming the corresponding program codes into a processing chip configured as the processing unit 13 via firmware design and executed by the processing unit 13 during the operation of the optical touch system 4. FIG. 16 is merely used to illustrate an implementation of the object detection method for the optical touch system 4 and the instant disclosure is not limited thereto.

Additionally, the present disclosure also discloses a non-transitory computer-readable media for storing the computer executable program codes of the object detection method depicted in FIG. 5 and FIG. 16, the method for generating the first light distribution curve and the method defining the bright region depicted in FIG. 10, Step S1303˜Step S1311 of the calibration method depicted in FIG. 13, the generation of touch reference values of FIG. 14 as well as the object detection and determination method depicted in FIG. 6˜FIG. 9. The non-transitory computer-readable media may be a floppy disk, a hard disk, a compact disk (CD), a flash drive, a magnetic tape, accessible online storage database or any type of storage media having similar functionality known to those skilled in the art.

In summary, an optical touch system and an object detection method thereof are disclosed in the present disclosure, in which the object detection method may be applied to an optical touch system having at least an image sensor e.g., the optical touch system. The object detection method can quickly and accurately determine whether an approaching object is touching the touch surface of the optical touch system or hovering over the touch surface by comparing and analyzing the brightness difference between a shadowed region defined in an image captured across the touch panel and a corresponding region defined in a background image. The object detection method further is capable of deciding whether to compute the touch position of the object detected, thereby effectively improving the recognition rate of touch points in the optical touch system and the operation efficiency of the optical touch system.

The present disclosure further provides a calibration apparatus for the optical touch system, which by placing calibration objects and detecting the shadowed image information of the calibration points formed therefrom, can quickly establish a set of predefined brightness parameters associated with the shadowed region and provide a basis for the optical touch system to determine or identify the touch state of an object on the touch panel.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. An object detection method, comprising:
storing a lookup table of touch reference values, wherein the lookup table of touch reference values records a plurality of touch reference values associated with image positions of a plurality of calibration object images formed in calibration images captured by a first image sensor;
capturing a first image with the first image sensor, wherein the first image has at least a first object image corresponding to a pointer formed therein;
generating a first light distribution curve associated with the first image;
defining a first detection region in the first light distribution curve;
obtaining at least one touch reference value associated with the image position of the first object image in the first image using the lookup table of touch reference values; and
comparing at least one brightness value in the first detection region of the first light distribution curve with the at least one touch reference value obtained.

2. The object detection method according to claim 1, further comprising:
determining whether the pointer is touching a touch panel or hovering over the touch panel according to the comparison result.

3. The object detection method according to claim 2, further comprising:
when the comparison result indicates that the pointer is touching the touch panel, computes a touch position of the pointer relative to the touch panel according to the image position of the first object image formed in the first image.

4. The object detection method according to claim 3 further comprising:
when the comparison result indicates that the pointer is hovering over the touch panel, stops computing the touch position of the pointer relative to the touch panel.

5. The object detection method according to claim 2, wherein the step of comparing the at least one brightness value in the first detection region with the at least one touch reference value comprises:
determining whether a minimum brightness value of a plurality of brightness values in the first detection region of the first light distribution curve is less than a predefined brightness value of a plurality of touch reference values associated with the image position of the first object image in the first image; and
when the minimum brightness value of the plurality of brightness values in the first detection region of the first light distribution curve is less than the predefined brightness value, determines that the pointer is touching the touch panel.

6. The object detection method according to claim 2, wherein the step of comparing the at least one brightness value in the first detection region with the at least one touch reference value comprises:
computing an average brightness value of the plurality of brightness values in the first detection region of the first light distribution curve; and
determining whether the average brightness value of plurality of brightness values in the first detection region of the first light distribution curve is less than a predefined average brightness value of a plurality of touch reference values associated with the image position of the first object image in the first image; and
when the average brightness value of the plurality of brightness values in the first detection region of the first light distribution curve is less than the predefined average brightness value, determines that the pointer is touching the touch panel.

7. The object detection method according to claim 1, wherein the step of defining the first detection region comprises:
defining a first left boundary and a first right boundary in the first light distribution curve associated with the first object image in the first image to define the first detection region that corresponds to the first object image in the first light distribution curve.

8. The object detection method according to claim 2, further comprising:
capturing a second image across the touch panel with a second image sensor, wherein the second image has at least a second object image corresponding to the pointer formed therein;
generating a second light distribution curve associated with the second image;
determining whether the pointer is touching the touch panel or hovering over the touch panel by respectively comparing a plurality of brightness values in the first detection region of the first light distribution curve and a plurality of brightness values in the second detection region of the second light distribution curve with a plurality of touch reference values associated with the image position of the first object image in the first image and the image position of the second object image in the second image; and
when the minimum brightness value of the brightness values in the first detection region of the first light distribution curve and the minimum brightness value of the brightness values in the second detection region of the second light distribution curve are simultaneously less than a predefined minimum brightness value, or when the average brightness value of the brightness values in the first detection region of the first light distribution curve and the average brightness value of the brightness values in the second detection region of the second light distribution curve are simultaneously less than a predefined average brightness value, determines that the pointer is touching the touch panel;
wherein the first image sensor and the second image sensor are respectively disposed at different locations on the touch panel and are configured to have overlapping sensing area.

9. The object detection method according to claim 8, further comprising:
when either the minimum brightness value of the brightness values in the first detection region of the first light distribution curve and the minimum brightness value of the brightness values in the second detection region of the second light distribution curve is greater than the predefined minimum brightness value, or when either the average brightness value of the brightness values in the first detection region of the first light distribution curve or the average brightness value of the brightness values in the second detection region of the second light distribution curve is greater than the predefined average brightness value, determines that the pointer is hovering over the touch panel.

10. The object detection method according to claim 8, wherein the step of defining the second detection region comprises:
defining a second left boundary and a second right boundary in the second light distribution curve associated with the second object image in the second image to define the second detection region that corresponds to the second object image in the second light distribution curve.

11. The object detection method according to claim 2, wherein the step of comparing the at least one brightness value in the first detection region of the first light distribution curve with the at least one touch reference value obtained comprises:
capturing a background image across the touch panel with the first image sensor to generate a background light distribution curve;
computing the brightness difference between the first light distribution curve and the background light distribution curve to generate a first brightness difference data; and
comparing at least one brightness difference value of the first brightness difference data with the at least one touch reference value.

12. The object detection method according to claim 11, wherein the step of comparing the at least one brightness value in the first detection region of the first light distribution curve with the at least one touch reference value comprises:
comparing the maximum brightness difference value of the first brightness difference data with a predefined brightness difference value of a plurality of touch reference values associated with the image position of the first object image in the first image; and
when the maximum brightness difference value of the first brightness difference data is greater than the predefined brightness difference value, determines that the pointer is touching the touch panel.

13. The object detection method according to claim 11, wherein the step of comparing the at least one brightness value in the first detection region of the first light distribution curve with the at least one touch reference value comprises:
computing an average brightness difference value for a plurality of brightness difference values in the first brightness difference data;
comparing the average brightness difference value with a predefined average brightness difference value of a plurality of touch reference values associated with the image position of the first object image in the first image; and
when the average brightness difference value of the first brightness difference data is greater than the predefined average brightness difference value, determines that the pointer is touching the touch panel.

14. The object detection method according to claim 11, wherein the step of comparing the at least one brightness value in the first detection region of the first light distribution curve with the at least one touch reference value further comprises:
capturing a second image across the touch panel with a second image sensor, wherein the second image has at least a second object image corresponding to the pointer formed therein;
generating a second light distribution curve associated with the second image;
computing the brightness difference between the second light distribution curve and the background light distribution curve to generate a second brightness difference data; and
comparing at least one brightness difference value of the first brightness difference data and at least one brightness difference of the second brightness difference value respectively with the at least one touch reference value;
wherein, the first and the second image sensors are respectively disposed at different locations on the touch panel and are configured to have overlapping sensing area.

15. The object detection method according to claim 14, wherein the step of comparing the at least one brightness difference value of the first brightness difference data and the at least one brightness difference of the second brightness difference value with the at least one touch reference value, further comprises:
when a first maximum brightness difference value of the first brightness difference data and a second maximum brightness difference value of the second brightness difference data are simultaneously greater than a predefined brightness difference value of a plurality of touch reference values, determines that the pointer is touching the touch panel.

16. The object detection method according to claim 14, wherein the step of comparing the at least one brightness difference value of the first brightness difference data and the at least one brightness difference of the second brightness difference value with the at least one touch reference value, further comprises:
computing a first average brightness difference value of the brightness difference values in the first brightness difference data and a second average brightness difference value of the brightness difference values in the second brightness difference data, respectively; and
when the first average brightness difference value of the first brightness difference data and the second average brightness difference value of the second brightness difference data are simultaneously greater than a predefined average brightness difference value, determines that the pointer is touching the touch panel.

17. The object detection method according to claim 1, wherein the step of generating the first light distribution curve comprises:
capturing a background image across a touch panel with the first image sensor, wherein the background image does not contain the object image of the pointer;
comparing pixel values of each pixel column in the background image with a predetermined pixel value to define an upper brightness bound and a lower brightness bound in each pixel column, wherein each pixel lying between the upper brightness bound and the lower brightness bound has a pixel value greater than the predetermined pixel value;
defining a bright region in the background image according to the upper brightness bound and the lower brightness bound of each respective pixel column;
computing the sum of brightness of all pixels in each pixel column in the bright region of the background image to generate a background light distribution curve;
computing the sum of brightness of all pixels for each pixel column of the first image that correspond to the bright region of the background image; and
generating the first light distribution curve associated with the first image according to the computation result.

18. The object detection method according to claim 17, wherein the step of generating the lookup table of touch reference values comprises:
executing a calibration program;
driving the first image sensor to capture a plurality of calibration objects to generate a plurality of calibration images, with each calibration image having a calibration object image corresponding to each respective calibration object formed therein, wherein the positions of the plurality of calibration objects relative to the touch panel are known;
summing a plurality of pixels for each pixel column in each calibration image that correspond to the bright region of the background image to compute the sum of the brightness of each respective pixel column in the bright regions of the respective calibration images;
obtaining a plurality of calibration light distribution curves associated with the calibration images according to the computation result;
computing the touch reference values associated with the image position of the calibration object image in each respective calibration image according to the calibration light distribution curves; and
recording positions of the calibration objects relative to the touch panel and the touch reference values associated with image positions of calibration object images formed in the calibration images, so as to generate the lookup table of touch reference values.

19. The object detection method according to claim 18, wherein the touch panel has a first side, a second side, a third side opposite to the first side, and a fourth side opposite to the second side, the first and the third sides are connected through the second and the fourth sides, respectively, the first image sensor is disposed at a corner intersected by the first side and the second side, and the calibration objects are sequentially disposed along the first side, the second side, the third side, and the fourth side, wherein the calibration objects are disposed with equal spacing in between.

20. The object detection method according to claim 18, wherein the touch panel has a first side, a second side, a third side opposite to the first side, and a fourth side opposite to the second side, the first and the third sides are connected through the second and the fourth sides, respectively, the first image sensor is disposed at a corner intersected by the first side and the second side, and the calibration objects are disposed with equal spacing therebetween on the touch panel along a diagonal line of the touch panel.

21. The object detection method according to claim 18, wherein the step of computing touch reference values associated with image positions of calibration object images formed in the calibration images comprises:
computing the touch reference values associated with the image position of the calibration object image in each respective calibration image according to the calibration light distribution curves, the background light distribution curve, and a preset weighting factor.

22. The object detection method according to claim 18, wherein the step of obtaining the at least one touch reference value associated with the image position of the first object image in the first image comprises:
generating a touch calibration function by interpolation using the positions of the calibration objects relative to the touch panel and the touch reference values associated with the respective calibration objects;
generating the at least one touch reference value associated with the first object image by using the touch calibration function and the position of the pointer relative to the touch panel.

23. A calibration apparatus for an optical touch system, comprising:
a touch panel having a first side, a second side, a third side opposite to the first side, and a fourth side opposite to the second side;
at least one light-emitting component, configured to operatively generate a light illuminating the touch panel;
a first image sensor disposed at a corner intersected by the first and the second sides, the sensing area of the first image sensor at least encompassing the second side and the third side of the touch panel;
an auxiliary reference device comprising a plurality of reference marks, the reference marks being placed on an auxiliary frame, the reference marks comprising at least a first set of reference marks and a second set of reference marks, wherein when the auxiliary reference device is placed on the top of the touch panel, the first set of reference marks is positioned on the fourth side and the second set of reference marks is positioned on the third side; and
a calibration processing unit coupled to the first image sensor;
wherein the calibration processing unit drives the first image sensor to capture a plurality of first calibration images containing a plurality of calibration object images corresponding to a plurality of calibration objects disposed on the touch panel and the reference marks, obtains a plurality of touch reference values associated with the calibration object images, computes the position of each calibration object relative to the touch panel thereafter according to the image positions of the calibration object images and the reference marks formed in the first calibration images captured, and generates a lookup table of touch reference values according to the positions of the calibration objects relative to the touch panel and the associated touch reference values.

24. The calibration apparatus for the optical touch system according to claim 23, wherein the calibration processing unit generates a first calibration light distribution curve for each first calibration image, the calibration processing unit compares each first calibration light distribution curve with a background light distribution curve of a background image thereafter to define a first region in each respective first calibration light distribution curve, and the calibration processing unit generates the touch reference values associated with the image position of the calibration object image in each respective first calibration image according to a plurality of brightness values in each respective first region.

25. The calibration apparatus for the optical touch system according to claim 24, wherein the touch reference values comprise at least one of a predefined brightness value that corresponds to the minimum brightness value of the brightness values in the first region, a predefined average brightness value that corresponds to the average brightness value of the brightness values lying in the first region, a predefined brightness difference value that corresponds to the maximum brightness difference computed between the first calibration light distribution curves and the background light distribution curve over the first region, and a predefined average brightness difference value that corresponds to the average brightness difference value computed between the first calibration light distribution curves and the background light distribution curve over the first region.

26. The calibration apparatus for the optical touch system according to claim 23, wherein the first image sensor and the second image sensor respectively comprise a charge-coupled device (CCD) image sensor or a complementary metal oxide semiconductor (CMOS) image sensor.

27. The calibration apparatus for the optical touch system according to claim 23, wherein the light-emitting component comprises at least a light-emitting element and the light-emitting element comprises one of an infrared light emitting diode and an ultraviolet light emitting diode.

28. The calibration apparatus for the optical touch system according to claim 23, wherein the light-emitting component is a reflective mirror or a reflective cloth.

29. The calibration apparatus for the optical touch system according to claim 23, wherein the calibration objects are sequentially disposed along the first side, the second side, the third side, and the fourth side of the touch panel, and the calibration objects are disposed with equal spacing in between.

30. The calibration apparatus for an optical touch system according to claim 23, wherein the calibration objects are equally disposed along a diagonal line of the touch panel.
